(19) United States
(12) Patent Application Publication
(10) Pub. No.: US 2014/0068679 A1
(43) Pub. Date: Mar. 6, 2014

(54) INFORMATION PROCESSING APPARATUS, INFORMATION PROCESSING METHOD, DIGITAL TELEVISION RECEIVING APPARATUS, AND STORAGE MEDIUM

(71) Applicant: KABUSHIKI KAISHA TOSHIBA, TOKYO (JP)

(72) Inventors: Yuki KANEKO, Kawasaki-shi (JP); Hideo KATAOKA, Tokyo (JP)

(21) Appl. No.: 14/010,949

(22) Filed: Aug. 27, 2013

Related U.S. Application Data
(63) Continuation of application No. PCT/JP2013/058202, filed on Mar. 14, 2013.

(30) Foreign Application Priority Data
Aug. 30, 2012 (JP) 2012-190103

(51) Int. Cl. H04N 21/462

(52) U.S. Cl. CPC H04N 21/4622
USPC 725/49

(57) ABSTRACT

According to one embodiment, a content output module outputs viewing content to a display module. A service menu list display module displays a service menu related to the content in list form on the display module when an instruction to acquire a service from a server is received, while the content is being output to the display module. Then, a related service menu switching display module switches to a further related service menu and displays the menu in response to a subsequent specification input according to a display state of the service menu.

### CROSS REFERENCE TO RELATED APPLICATIONS

This application is a Continuation Application of PCT Application No. PCT/JP2013/058202, filed Mar. 14, 2013 and based upon and claiming the benefit of priority from Japanese Patent Application No. 2012-190103, filed Aug. 30, 2012, the entire contents of all of which are incorporated herein by reference.

### FIELD

Embodiments described herein relate generally to an information processing apparatus, an information processing method, a digital television receiving apparatus, and a storage medium.

### BACKGROUND

In recent years, the Internet service business has grown actively. In the Internet service business, information is exchanged in a communication environment between a server on the Internet and a personal computer and/or a mobile terminal (e.g., a cell-phone, a tablet, or a personal digital assistant (PDA)).

A home television apparatus (hereinafter, referred to as a TV apparatus) has the advantage that the monitor screen is larger and clearer than that of another apparatus that can display a screen (e.g., a personal computer, a cell-phone, or a tablet). In addition, the home TV apparatus further has the advantage of being capable of being equipped with a sophisticated audio system. A recent TV apparatus can connect with the Internet. On the other hand, a small personal computer, a cell-phone, a tablet, or the like has the advantage of portability.

When the TV apparatus is connected to the Internet, it is conceivable that the user uses the browser while two or more of the family members are watching a program on the TV apparatus at the same time, or while one of the family members is watching a program on the TV apparatus. Therefore, as for the Internet connection of the TV apparatus, the mode of using the TV apparatus differs from that of a personal computer. Accordingly, when the TV apparatus is operated and controlled with the same specification as that of the personal computer, the user might suffer inconvenience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a menu screen displayed on a screen of a display module of a television apparatus according to an embodiment;

FIG. 2 shows another example of the menu screen displayed on the screen of the display module of the television apparatus according to the embodiment;

FIG. 3 shows still another example of the menu screen displayed on the screen of the display module of the television apparatus according to the embodiment;

FIG. 4 shows still another example of the menu screen displayed on the screen of the display module of the television apparatus according to the embodiment;

FIG. 5 shows a state where an information processing apparatus of the embodiment has been incorporated in a digital television receiving apparatus;

FIG. 6 is a block diagram selectively showing a characteristic configuration of a cloud application module 231 in FIG. 5;

FIG. 7 shows the relationship between a TV apparatus 300 and a time cloud service server 411 when a scene information function is used in the embodiment;

FIG. 8 shows the relationship between the TV apparatus 300 and the time cloud service server 411 when a scene list function is used in the embodiment;

FIG. 9 shows the relationship between the TV apparatus 300 and the time cloud service server 411 when a scene play function is used in the embodiment;

FIG. 10 shows an example of servers included in the time cloud service server 411 in the embodiment;

FIG. 11 shows an example of components in a metadata server of FIG. 9 in the embodiment;

FIG. 12 shows a configuration of an information processing apparatus and various functional modules of a DTV according to the embodiment;

FIG. 13 is a table that describes the definitions and meanings of terms and abbreviations used in the embodiment;

FIG. 14A is a table that describes an example of scene information and scene list functions in the embodiment;

FIG. 14B is a table that describes an example of scene information and scene list functions in the embodiment;

FIG. 14C is a table that describes an example of scene information and scene list functions in the embodiment;

FIG. 15 is a table that describes the definitions and meanings of terms and abbreviations used in the embodiment;

FIG. 16 shows an example of the transition of screens related to scene information/scene list functions in the embodiment;

FIG. 16A shows a part of FIG. 16 in detail;

FIG. 16B also shows other parts of FIG. 16 in detail;

FIG. 17 shows an example of the transition of screens at the time of the start of an application in the embodiment;

FIG. 18 shows an image of providing service when scene information is used in the embodiment;

FIG. 19A illustrates a brief overview of screen transition;

FIG. 19A1 illustrates a part of FIG. 19A in detail;

FIG. 19A2 illustrates other parts of FIG. 19A in detail;

FIG. 19B illustrates a brief overview of screen transition;

FIG. 19C illustrates a brief overview of screen transition;

FIG. 19D illustrates a brief overview of screen transition;

FIG. 20 illustrates the details of screen transition in the embodiment;

FIG. 21 illustrates the details of screen transition in the embodiment;

FIG. 22 illustrates the details of screen transition in the embodiment;

FIG. 23 illustrates the details of screen transition in the embodiment;

FIG. 24 illustrates the details of screen transition in the embodiment;

FIG. 25 shows an example of a screen in the embodiment;

FIG. 26 shows an example of a screen in the embodiment;

FIG. 27 shows an example of a screen in the embodiment;

FIG. 28 shows an example of a screen in the embodiment;

FIG. 29A is a table that describes an example of metadata included in scene information;

FIG. 29B is a table that describes an example of metadata included in scene information;

FIG. 29C is a table that describes an example of metadata included in scene information; and

FIG. 29D is a table that describes an example of metadata included in scene information.

### DETAILED DESCRIPTION

Various embodiments will be described hereinafter with reference to the accompanying drawings.

In general, according to one embodiment, there are provided an information processing apparatus, an information processing method, a digital television receiving apparatus, and a storage medium.

According to one embodiment, not only the function of informing the user but also the usability can be improved in an Internet (also referred to as a network) connection. An information processing apparatus comprising: a first controller, a second controller and a third controller. The first controller is configured to output viewing content to a display module. The second controller is configured to display a service menu related to the content in a list form on the display module when an instruction to acquire a service from a specific server has been received while the content is being output to the display module. And the third controller is configured to switch to a further related service menu and display the further related service menu in response to a subsequent specification input according to a display state of the service menu.

According to another embodiment, it is possible to make good use of the advantages of a mobile terminal or the like connected to the Internet.

An embodiment of the present disclosure basically includes a unit that displays not only viewing content but also a service menu related to the content in list form when an instruction to start a cloud service has been given while content is being viewed and a unit that switches to a related service menu and displays the menu according to a display state.

In addition, another embodiment basically includes an overall controller that communicates with a network and a view control module. The view control module outputs a menu image obtained in a case where the overall controller has gone into communication with the network as a demonstration image when the overall controller is out of communication with the network.

The overall controller includes a login data management module and a communication data management module. The login data management module manages a common login identifier for more than one person and a dedicated login identifier for an individual. The communication data management module distinguishes between communication data corresponding to the common login identifier and communication data corresponding to the dedicated login identifier, thereby selecting display output.

An embodiment will further be described with reference to the drawings.

An information processing apparatus concerning a calendar according to the invention may be configured to be stand-alone or incorporated in a set-top box, a TV apparatus, a recorder, a mobile terminal, or the like. As an example, a case where an information processing apparatus and an information processing method according to the embodiment have been applied to a TV apparatus will be explained.

The information processing apparatus of the embodiment includes a unit that displays not only viewing content but also a service menu related to the content in list form when an instruction to start a cloud service has been given while content is being viewed and a unit that switches and displays related service menus according to a display state.

According to another embodiment, the information processing apparatus includes an overall controller that can connect to a network and a view control module. With the overall controller being out of communication with the network, the view control module can demonstrate a menu image to be obtained when the overall controller has gone into communication with the network.

The overall controller includes a login data management module and a communication data management module. The login data management module manages a common login identifier for more than one person and a dedicated login identifier for an individual. The communication data management module distinguishes between communication data corresponding to the common login identifier and communication data corresponding to the dedicated login identifier, thereby selecting a display output.

The communication data management module controls communication data corresponding to the dedicated login identifier privately (no openly) when the common login identifier has logged in.

The server may manage login states and logout states of a large number of information processing apparatuses (clients) with a table. In addition, the login management module may transmit a login identifier currently logging in to the server periodically. This enables the server to grasp the login states of a large number of information processing apparatuses (clients) more accurately.

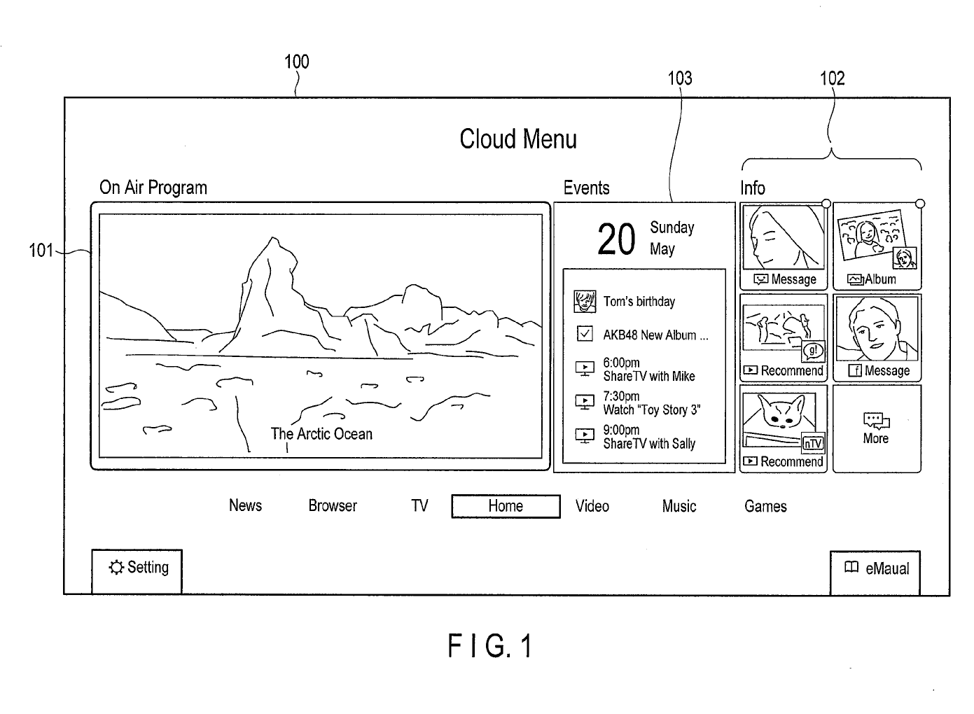

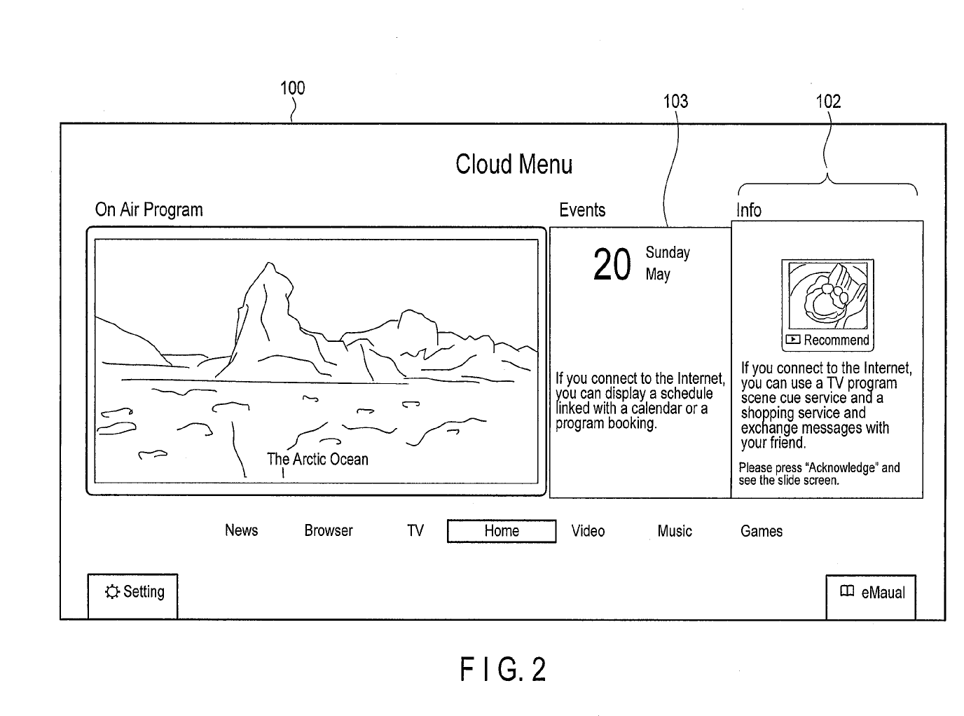

FIGS. 1 and 2 show examples of a menu image in a demonstration state. In a display area 101 on the left side of a screen 100, an image of a program currently being broadcast or an image of a program being reproduced from a recording device is displayed. In a display area 102 on the right side of the screen 100, a plurality of small-sized guide images are displayed, increasing as follows: one, two, three, . . . . When the number of guide images in the display area 102 has reached, for example, six (see FIG. 1), for example, the message “If you connect to the Internet, you can use a TV program scene cue service and a shopping service and exchange messages with your friend” is displayed in the display area 102 as shown in FIG. 2. In a display area 103 in the center, a calendar is displayed together with a brief summary of information on various events of the day (FIG. 1). Then, each time a certain period of time has passed, the message “If you connect to the Internet, you can display a schedule linked with a calendar or a program booking” is displayed in the central display area 103 as shown in FIG. 2.

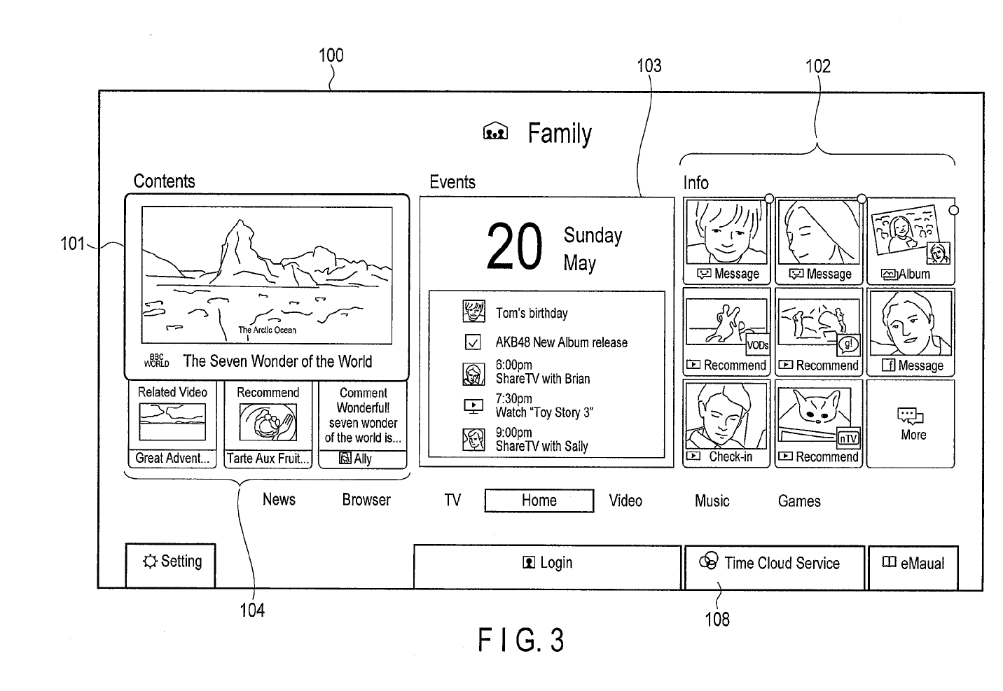

FIG. 3 shows a state where the screen 100 is displayed when the information processing apparatus has been connected to the Internet and login has been started with a family ID. In the display area 102, guide images for various transmit-receive boxes to receive notices from your family or friends and recommended data are displayed. The transmit-receive boxes include an outlook, a mail, a message, and a recommended data box. A unique name can be added to a screen frame representing each transmit-receive box. Alternatively, a favorite image can be selected from an image file and added as a guide image. When a message or recommended data has arrived at the transmit-receive box, a corresponding guide image is displayed so as to be marked with, for example, a circle, changed in the frame color, or changed in the frame brightness periodically. When a plurality of recommended data items have arrived at the transmit-receive box, a plurality of circles may be displayed so as to be added to corresponding guide images.

The transmit-receive box (the state of the display area 102 in FIG. 3) can be used for communication between, for example, family members or between family members and their friends. There may be a case where a photo album may be received from a friend or a brother living in a distant place. In addition, there may be a case where recommended data may be received from a friend. The recommended data includes, for example, recommended program information and recommended shopping information. It further includes recommended scene information and recommended performer information. An example of using the guide image will be explained later.

In addition, a plurality of function-related guide images are displayed in an area 104 under the area 101. The function-related guide images are used when the user operates the information processing apparatus in connection with a reproduced image displayed in the area 101. The details of an example of using the guide image will be explained later. When communication regarding the reproduced image displayed in the area 101 is being performed between the user and an external server (or another user), the guide image can be used.

<Example of Using Guide Images in the Display Area 102>

The user can operate, for example, a remote controller (e.g., a mobile terminal may have a remote controller function) to move a cursor to a desired guide image (e.g., a guide image for a message from a mother to her child). The guide image may be referred to as an operation button. The cursor is displayed as, for example, a frame enclosing a guide image. When the cursor is located on a desired guide image, an acknowledge button on the remote controller is pressed (or clicked), causing a transmit-receive box corresponding to the guide image to be opened, with a result that, for example, a message is displayed. For example, the whole or half of the area 102 can be used for the massage.

In addition, the user can operate the remote controller to open a transmit-receive box for recommended data. The recommended data may be, for example, recommended program information on a recommended program sent from a friend or recommended shopping information. At this time, suppose the user has become interested in the recommended program and wants to watch the program. At this time, when the user moves the cursor to a selection button for the displayed recommended program information and presses the acknowledge button, the TV apparatus can start to reproduce the program automatically. In this case, the reproduced image of the program may be displayed on a small screen. Then, when the user has pressed the acknowledge button, the reproduced image may be displayed on a large screen.

The transmit-receive box can be used to send a message to the receiver's transmit-receive box or mobile terminal. The recommended program information is displayed as, for example, a title name, a scene of a part of the program, a performer's name, or an image of the performer. The recommended program information further includes a broadcast channel number, broadcast time and date, such information as a performer's prologue, and a content server address.

A method of causing the TV apparatus at this time to acquire program content include a first method of driving a recording device connected to the TV apparatus to acquire program content and a second method of acquiring program content by downloading the content from a content server via the Internet. In the first method, a program list search function for a program recorded in the recording device operates. In the second method, the address of a content server included in the preceding recommended program information is used.

The recommended program information may include data processed for the user to acquire the program content easily. That is, the recommended program information recommended by the friend is uploaded from the friend's device to the server. On the server, the recommended program information is processed into program information the user can use. The reason why the recommended program information is processed is that a broadcast program may differ in broadcast channel number, broadcast time slot, or the like from region to region. Therefore, program information is processed (e.g., the broadcast channel number, broadcast time slot, and the like are processed) on the server so that the user can easily search for the same program as that recommended by the friend and obtain the program and then offered to the user. The method of acquiring recommended program information further includes a method of acquiring the information from calendar information, which will be explained later.

In addition, using a guide image in the display area 102, a mail, a short message, or the like can be transmitted to a family member or to a friend entered in a management module that manages the guide image. The friend in this case is a friend common to the family members. Information on another family or a friend common to the family members is recognized by a home management module that stores and manages home guide images and entered in the management module.

<Example of Using Guide Images in the Display Area 104>

For example, suppose a drama (displayed in the area 101) in a program the user is now watching has a scene the user likes or a scene where the user's favorite performer appears. In such a case, the user operates the remote controller, selects a recommended guide image, and presses the acknowledge button. Then, program information on the program the user is now watching is uploaded to a server as attention (or notice) program information. The server can use the attention program information as material for creating recommended program information and/or information for creating a tag list for the program. Since attention program information on various programs is sent from many viewers to the server, the server can perform statistical processing on the basis of the attention program information and create a program information list of programs ranked in descending order of popularity.

In addition, the user can operate the remote controller to select a comment guide image and press the acknowledge button. Then, a screen that prompts the user to input a short message about a program (a program image displayed in the area 101) the user is watching appears, enabling the user to input a message. The user can input a message from, for example, the remote controller or the keyboard display of the mobile terminal.

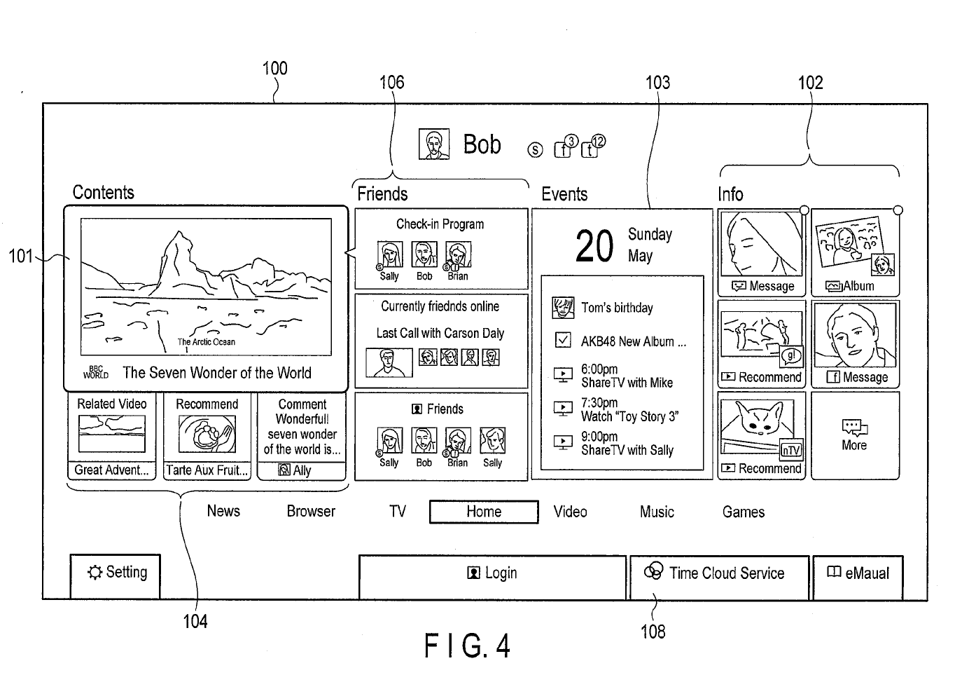

FIG. 4 shows a display state of the screen 100 when the information processing apparatus has been connected to the Internet and logged in with a personal ID. In the screen 100, a display area 106 for guide images to perform communication with a friend is obtained between the area 101 and the area 103. In the display area 106, there are, for example, three types of guide images. In an upper guide image (Check-in Program), a list of others (friends) simultaneously watching a program the user is now watching is displayed. In a middle guide image (Currently friends online), although the information processing apparatus has been connected to a network, a list of others (friends) watching a program differing from the program the user is now watching is displayed. In a lower guide image (Friends), a list of others (friends) with the information processing apparatus not connected to a network is displayed. The login state of the information processing apparatus is transmitted to the server periodically. Therefore, the server can distinguish between a user not connected to the network, a user connected to the network, and a user who is connected to the network and is watching the same program. The server is monitoring the statuses of a plurality of users. Accordingly, the information processing apparatus can present three types of guide images as shown in the display area 106.

<Example of Using Guide Images in the Display Area 106>

For example, when son B of friend A appears in a drama of a program the user is now watching, the user may want to inform friend A or friend A's family of this. In addition, when friend A is searching for stray dog C and the user has heard the news about stray dog C, the user may want to inform friend A or friend A's family of this. In those cases, the user can use guide images displayed in the area 106.

The user can operate the remote controller to select, with a cursor, a guide image in which a desired friend is displayed and press the acknowledge button. Then, there appears a screen that enables the user to send a message to the selected friend.

For the communication, the user can use guide images in which a recommendation and a message have been written and which are displayed in the display area 102. The user can operate the remote controller to select, with the cursor, a guide image in which a desired image has been displayed and press the acknowledge button. Then, a message for a family member or a person entered in the transmit-receive box in the selected image can be transmitted. Guide images in the display are 106 can be used primarily for private communication.

<Example of Using a Guide Image in the Display Area 103>

In this guide image, not only is a calendar displayed, but also the titles of events and a schedule of the day are displayed briefly. If the user wants to know detailed information on the events or schedule, the user selects the title of an event or a schedule with the cursor and clicks the title, thereby further displaying detailed information. The detailed information can be browsed with, for example, a URL address.

In the calendar, the user's schedule can be written. When the display area for the calendar has been selected with the cursor, calendar use items are displayed. When a schedule write item has been selected, a schedule can be input from the remote controller or mobile terminal.

<Movement of Operation Screen>

The guide images shown in FIGS. 2, 3, and 4 excluding a viewing image in the area 101 can be displayed on a mobile terminal which is a touch input operation module with a display module. That is, the information processing apparatus can move the guide image and a manipulate signal corresponding to the guide image to a mobile terminal via a communication function of the TV apparatus. This enables the mobile terminal to maintain communication with the TV apparatus and manipulate the information processing apparatus making use of guide images as described above.

<Cloud Service Button>

On the screen 100, a button 108 (whose name and display position are not restricted to this embodiment) called, for example, “Time Cloud Service” is displayed.

Now, suppose, while the user is watching content displayed in the area 101, the user selects the cloud service button 108 with the cursor and clicks the button 108 to give a cloud service instruction. Then, a cloud service application in the apparatus can be started. When the cloud service has been started, not only viewing content but also a service menu related to the content is offered from a time cloud server, enabling the service menu to be displayed in list form. It is possible to switch between related service menus according to a display state and display the suitable one. Cloud services are available in various forms and will expand in various fields. As for cloud services, some typical examples will be explained later. The guide images shown in FIGS. 2, 3, and 4 may be activated when the button 108 is turned on and the apparatus is connected to the time cloud service server.

The apparatus may be connected to the cloud service server when a specific button on the remote controller or mobile terminal has been operated.

<A Block Configuration of the Information Processing Apparatus>

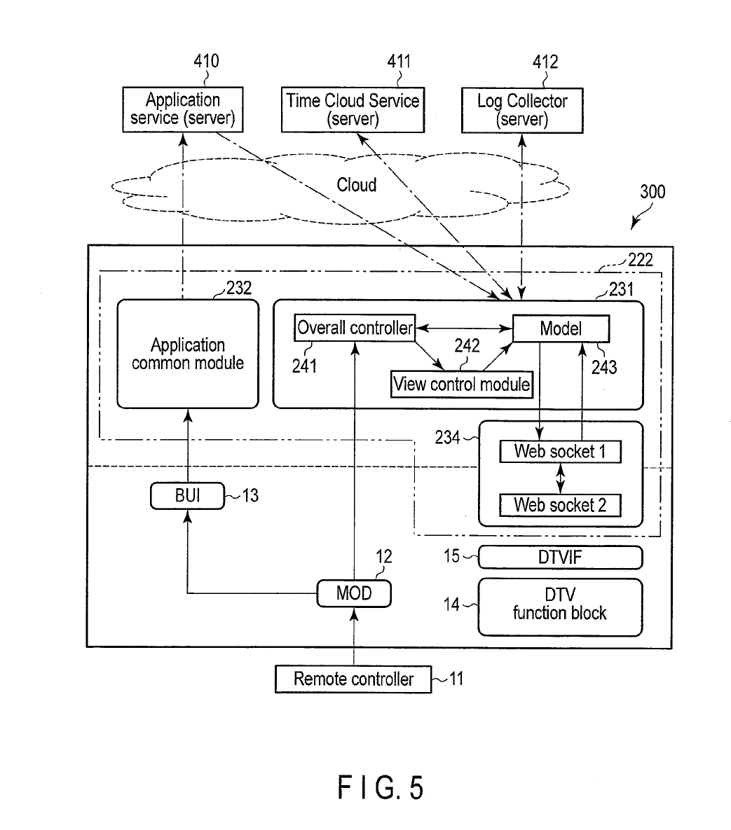

FIG. 5 shows an overall configuration of the TV apparatus 300 to which the information processing apparatus and the information processing method according to the embodiment have been applied. In FIG. 5, the basic functions (including television signal reception, demodulation, control signal processing, 3-D-related signal processing, recording, audio processing, video processing, and a display function) of a digital television receiver (hereinafter, abbreviated as a DTV) are collectively called a DTV function block (or module) 14. The DTV function block 14 is connected to an information processing apparatus 222 via a DTV interface 15. The information processing apparatus 222 may be referred to as a browser section.

In the embodiment, the information processing apparatus 222 includes a cloud application module 231, an application common module 232, and a socket module 234. This classification is not restrictive. The cloud application module 231 may be defined as the information processing apparatus 222.

The socket module 234 includes a server web socket viewed from the DTV interface 15 and a client web server viewed from the browser.

The cloud application module 231 includes an overall controller 241, a view control module 242, and a model 243. The overall controller 241 performs various event processes in response to a command or an instruction. The overall controller 241 controls the view control module 242, thereby realizing various drawing processes. The view control module 242 can obtain various images and control signals in the aforementioned screen 100. The images and control signals based on the operation of the view control module 242 pass through, for example, the model 243 and socket 234 and are displayed as images and control buttons on the display module of the TV apparatus.

The model 243 can access a server, acquire information from a server, transmit information to a server, operate a DTV, and receive data from a DTV. Therefore, the model 243 can receive a message from the DTV and transmit the message to the server. In addition, the model 243 together with the view control module 242 can display the message received from the server on the screen of the display module of the DTV. As for servers, there are an application service server 410, a time cloud service server 411, and a log collector server 412. There are still other servers (not shown).

The user can manipulate the remote controller 11 to control the DTV and information processing apparatus 222. A manipulate signal from the remote controller 11 is distributed at a moderator 12. A key event distributed for use with the cloud application module 231 is input to the overall controller 241. A key event distributed for use with the application common module 323 is input to the application common module 232 via a browser user interface 13. The application common module 232 can request a specified application from an application server 410 according to an application request command. The application sent from the application server 410 is taken in by the cloud application module 231 via the model 243. The log collector server 412 can collect logs used in the information processing apparatus 222 and other connection devices.

The time cloud service server 411 can be connected to other various servers and other information processing apparatuses via the network. The time cloud service server 411 can send various service data items to the information processing apparatus. The time cloud service server 411 can relate video content to scene information or a tag list created by a metadata maker or a user. The related data items are arranged on, for example, a table.

Each block and its operation (including the aforementioned operations and operations described below) shown in FIG. 5 may, of course, be realized by a set of instructions constituting software (also referred to as a program). Of course, a processor or a central processing unit (CPU) for realizing data processing with software may be incorporated in each block of FIG. 5. The software, which is stored in a memory (storage medium), can be upgraded. The data (software) in the memory can be read by a computer.

The DTV, which includes a plurality of digital tuners, can receive a plurality of channels at the same time. When signals on a plurality of channels have been demodulated, a plurality of streams are obtained. Each stream includes packets of a television program, a control signal, and the like. The streams of a plurality of programs on a plurality of channels are recorded into, for example, a hard disk drive (HDD) connected via a USB connection cable. The HDD can also record management information for managing program information on recorded programs.

<Relationship Between the Time Cloud Service Server and the Information Processing Apparatus>

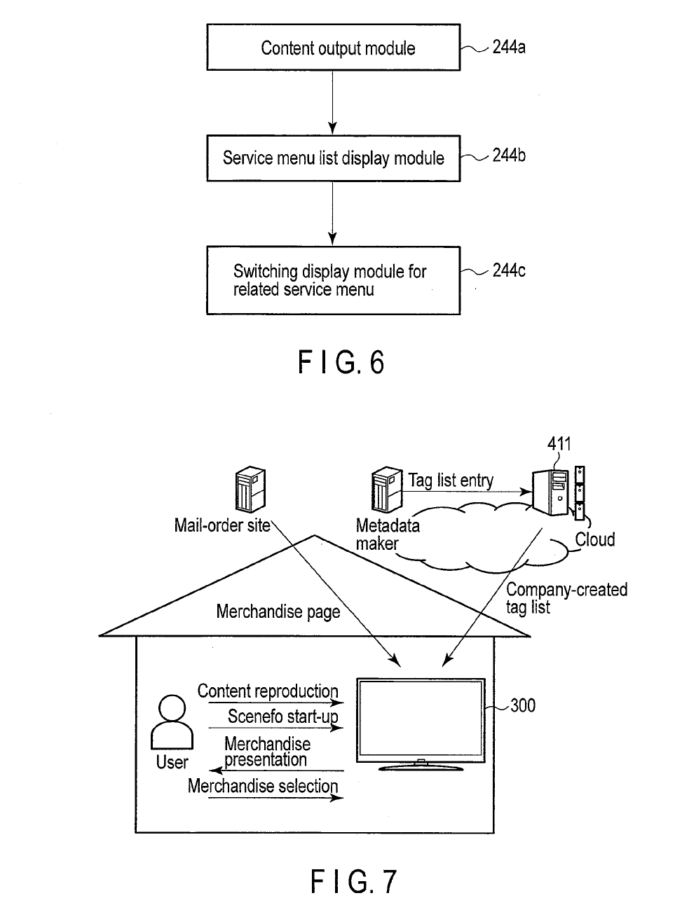

FIG. 6 shows a configuration of a module (in either software or hardware) composed of the overall controller 241, view control module 242, and model 243 in FIG. 5. A content output module 244a outputs viewing content to the display module. When an instruction to request a service from a specific server has been input while content is being output to the display module, a service menu list display module 244b can cause the display module to display a service menu related to the content in list form. A switching display module 244c can switch to and display a further related service menu according to the display state of the service menu in response to the input of a subsequent instruction. Hereinafter, various service functions related to this function will be explained.

<Scene Information Function (Also Referred to as Scenefo)>

FIG. 7 schematically shows the relationship between the TV apparatus 300 and the time cloud service server 411 when a scene information function (Scenefo) is used. In the embodiment, a service where video content is connected to scene information is used as scene information, which is abbreviated as, for example, “Scenefo.”

While the user is watching a program, if the user has found a curious scene, the user presses, for example, “Scene information key” on the remote controller (preferably in a state where the time cloud service button 108 of FIG. 4 is on). Alternatively, when a curiosity button (a curiosity key) is displayed in the area 104, the user presses the key. Then, the scene information service application starts. At the same time, the browser is also activated. Next, the user can browse a tag list or a scene list obtained by collecting scenes related to curious scenes as a plurality of tags. More than one tag list or more than one scene list may be used. In a normal tag list, a plurality of tags have been created in the same program. In a scene list, scenes in the same program and scenes in another program may be created in a unified manner. The tag list and scene list are also included in scene information. The scene information further includes various pieces of information as explained later.

Some tag lists or scene lists may be created by metadata makers or general users and uploaded to the time cloud service server 411.

Here, a tag list or a scene list is interval information whereby a scene in which the same performer appears can be segmented in units of several seconds or several tens of seconds in, for example, a certain program. As the interval information, a reproduction elapsed time (referred to as a relative time) since the starting position of a program is used. A pair of the starting time of a scene and the ending time of the scene determines one scene unit.

The time cloud service server 411 refers to scene information (a program name, a channel number, a time location (also referred to as a relative time since the starting position) on a program of a curious scene) created on the basis of the manipulation of “Scene information key,” thereby determining a corresponding tag or scene. The tag is one of tag units constituting a tag list. The tag list is normally created in the same program. The scene is one of scene units constituting a scene list. The scene list can be created, extending not only into a list of a program the user is now watching but also over a plurality of programs. A scene list created over a plurality of programs can be created from a plurality of programs, for example, in the same or a similar genre.

The scene list is attached with, for example, such a name or a comment as represents a program. A plurality of different scenes may have been created for one scene in a program. The reason for this is that a scene the user is curious about may be a scenic backdrop, a car appearing in the scene, or an actor driving the car in the scene. Therefore, a scene list about landscapes, a scene list about cars, a scene list about actors, and the like may be created.

As described above, when the user operates “Scene information key” in a certain scene in a program, scene information on the corresponding scene is sent from the time cloud service server 411 to the information processing apparatus. That is, the apparatus includes a module that displays not only viewing content but also a service menu related to the content in list form when an instruction to start a cloud service has been given while the user is watching content.

A plurality of scenes regarding the scene information are displayed, for example, on the right side of the screen 100. The user can refer to a comment or a name displayed together with the scene, select a desired scene by manipulating the remote controller, and press the acknowledge button. Then, on the screen 100, various scenes concerning the selected scene are displayed in the form of category selection buttons, including “Merchandise information,” “Outlet information,” “Regional information,” “Personality information,” and “Tag reproduction.”

The display state of the screen 100 at this time means that more detailed information about the merchandise, outlets, regions, personalities, “Tag reproduction,” and the like that appeared in the curious scene can be provided. When “Tag reproduction” has been selected, this means that a tag can be reproduced. That is, the apparatus includes a module that switches and displays related service menus according to the display state.

When the user has selected, for example, the “Merchandise information” button, the screen 100 goes into a merchandise selling site browsing state. This is because scene information sent from the time cloud service server 411 includes not only scene list or tag list data but also a homepage address of the selling site or the like as extended link information.

When the user has selected the “Outlet information” button, the screen 100 can go to a guide site for outlets that appeared in the curious scene. When the user has selected the “Regional information” button, the screen 100 can go to a guide site for a tourist board or an administrative institution in the region. At this time, information sent from the time cloud service server 411 may include map information created on the basis of GPS information. This enables the user to check whether an outlet or the like is near the user's home, looking at a map.

In addition, when the user has selected the “Personality information” button, the screen 100 can move to a guide site for a profile of the actor, another program in which the actor appears, a tour of the theater, support group information, and the like. Moreover, another key may be caused to function as the “Scene information key.”

<Scene List Function (Also Referred to as SceneList>

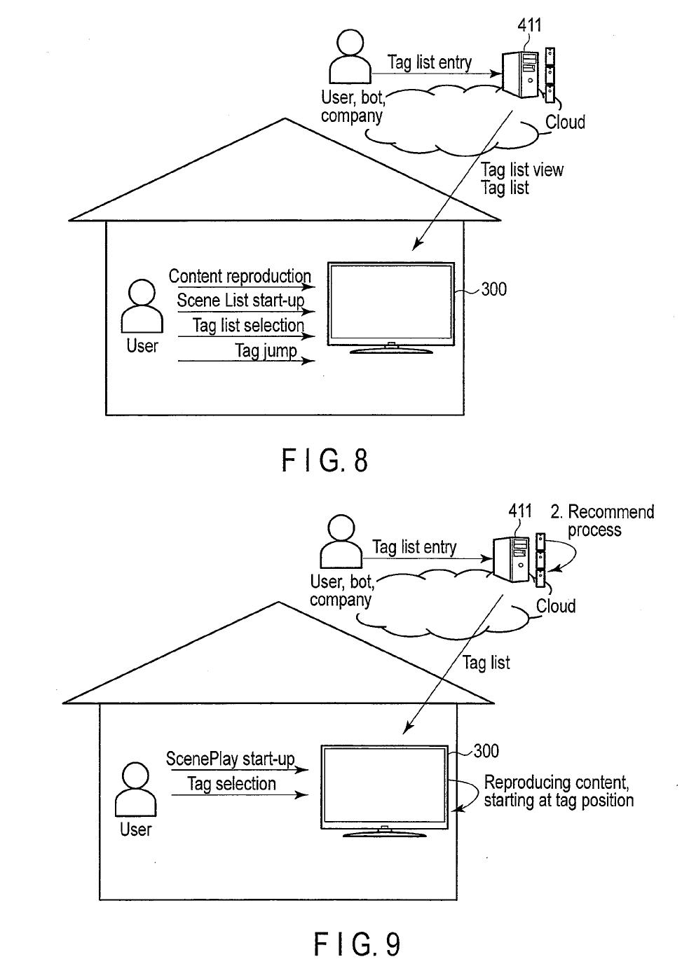

FIG. 8 schematically shows the relationship between the TV apparatus 300 and the time cloud service server 411 when a scene list function (SceneList) is used. The scene list function includes a module similar to that of the scene information function (Scenefo).

For example, in a soccer broadcast program, the user may want to see a scene of a goal shot or a scene of a specific player appearing on the field. Alternatively, in a sumo broadcast program, the user may want to see a scene of a specific wrestler appearing in the ring.

In such a case, when the user currently watching a program particularly wants to view a specific scene, the user presses, for example, “Scene list key” on the remote controller (preferably in a state where the time cloud service button 108 of FIG. 4 is on). Then, the scene list function starts, enabling the user to look at a scene list or a tag list of scenes equivalent to or similar to the scene the user wants to view.

The tag list is normally created in the same program. The scene list may include not only a list of the program the user is now watching but also a scene list covering a plurality of programs. For example, in a sumo broadcast program, a sumo match in which a specific wrestler appears is played once a day and sumo broadcast programs for a plurality of days have been recorded. Therefore, there is a scene list of a plurality of programs. The scene list is attached with, for example, such a name or a comment as represents the program. A plurality of scene lists or tag lists may have been created for one scene in a program. The scene list or tag list is also provided by the time cloud service server 411. That is, the apparatus includes a module that displays not only viewing content but also a service menu related to the content in list form when an instruction to start a cloud service has been given while the user is watching content.

When the user has selected a desired scene list name and pressed a play button, a scene according to the selected scene list or tag list is reproduced. The user can select a desired scene list name and press, for example, the acknowledge button. After the user has pressed the acknowledge button, scene cells constituting the scene list are displayed in array form. The array is in the order of time passage. Here, when the user has moved the cursor to the position of a desired scene cell and pressed the play button, reproduction is started with the scene specified by the cursor in the order in which the scenes have been arranged. That is, the apparatus includes a module that switches and displays related service menus according to the display state.

<Scene Play Function (Also Referred to as ScenePlay)>

FIG. 9 schematically shows the relationship between the TV apparatus 300 and the time cloud service server 411 when a scene play function (ScenePlay) is used. The scene play function includes a module similar to that of the scene information function (Scenefo).

As for a long program or a program watched part way through, the user may want to reproduce the program, starting with a part of the program. In addition, the user may want to reproduce the program, starting with a favorite scene. In such a case, the user clicks “Scene play” button (guide image) displayed in, for example, the area 104 of the screen 100 (preferably in a state where the time cloud service button 108 of FIG. 4 is on). Then, the image arrangement is changed and a plurality of small images of representative recommended scenes are displayed for the program the user is currently watching. For example, like the guide images shown on the right side of FIG. 3, a plurality of small images of representative recommended scenes are displayed. That is, the apparatus includes a module that displays not only viewing content but also a service menu related to the content in list form when an instruction to start a cloud service has been given while the user is watching content.

On the screen 100 in FIGS. 1 to 3, a guide image for “Scene play” is not displayed. However, various guide images can be displayed by moving the cursor to any one of the guide images in the area 104 and operating the scroll key on the remote controller. Since a guide image for “Scene play” is among the guide images, the user clicks the guide image. Then, a plurality of small images of representative recommended scenes are displayed in connection with the program the user is currently watching.

The user can start to reproduce the program, beginning with a scene of the small image by operating the remote controller to select the desired small image with the cursor and pressing the play button. That is, the apparatus includes a module that switches and displays related service menus according to the display state.

A recommended scene is created and prepared at, for example, the time cloud service server 411. Various methods of creating a recommended scene can be considered. The time cloud service server 411 collects, for example, curious scene information and/or recommended data from many clients (users). Then, statistics on program information on curious scene information are gathered and/or program information included in recommended data is taken. By the statistical processing, a plurality of scenes specified a number of times in program information are ranked on a program basis. A plurality of scenes high in program rank are set as representative scenes and representative scene information corresponding to the representative scenes is created. By doing this, in each program, a plurality of representative scenes are determined. The representative scene information includes the name of a program, the broadcast date and time of the program, and a relative time until the reproduction of a representative scene is started when the program is reproduced from the beginning.

In addition, the time cloud service server 421 is configured to be capable of receiving program recording destination (e.g., a hard disk drive, a DVD, or a BD) information and recorded program information from the user's information processing apparatus and grasping which program has been recorded in which recording medium. Therefore, when a representative scene is created, the TV apparatus can read content including the representative scene from the recording medium at high speed and present a plurality of representative scenes.

<Selection, Switch, or Transition of the Scene Information Function (Scenefo), Scene List Function (SceneList), and Scene Play Function (ScenePlay)>

The user may want to move to the scene list function (SceneList) or scene play function (ScenePlay) after having entered (a) the scene information function (Scenefo). In addition, the user may want to move to the scene play function (ScenePlay) or scene information function (Scenefo) after having entered (b) the scene list function (SceneList). Moreover, the user may want to move to the scene list function (SceneList) or scene information function (Scenefo) after having entered (c) the scene play function (ScenePlay).

The information processing apparatus has a function switching function for such a case. Various methods of switching functions can be considered. For example, after a scene list or a tag list has appeared, the scene information key, scene list key, and scene play key may be displayed, prompting the user to select any one of them. Alternatively, the scene information key, scene list key, and scene play key may be provided on the remote controller or displayed on the display module of a mobile terminal.

Furthermore, a scene-related function switching key may be prepared. The switching key may be configured to be operated repeatedly to switch the functions cyclically in this order even if any function is in operation: the scene information function (Scenefo), scene list function (SceneList), and scene play function (ScenePlay).

<Control Information Used when the Scene Information Function (Scenefo), Scene List Function (SceneList), or Scene Play Function (ScenePlay) is in Operation>

The time cloud service server 411 can transmit control information for controlling a TV function to the information processing apparatus. The time cloud service server 411, which has an information extended linkage function, can correlate data items transmitted from a metadata database server and many users with one another to create extended linkage data. The time cloud service server 411 has a correlating table for correlating data items with one another. Various methods of correlating data items with one another can be considered. For example, there is a method of correlating various data items with one another using a common identifier. In addition, sub-identifiers may be added to the identifiers, thereby classifying the degrees of correlating data items or the types of data items correlated with one another on the basis of the sub-identifiers.

As described above, scene information that correlates program information with outlets, merchandise, or the like can be created.

The expanded linkage data may include a control signal that controls the TV function automatically. For example, when the DTV function block 14 of the TV apparatus includes a 3D signal processing module, a control signal for bringing a content process into a 3D processing mode can be transmitted. The DTV function block 14 of the TV apparatus can response to the control signal. The 3D process includes the process of converting a 2D signal into a 3D signal. The 3D process further includes the process of supplying a 3D signal to a 3D display. The 3D display is available as a display that enables the user to see a 3D image with the naked eye or as a display that enables the user to see a 3D image by use of glasses. Therefore, when having determined that a scene or an image the user is going to see should be viewed in three dimensions and that the TV apparatus has a 3D function, the time cloud service server 411 can transmit a control signal that brings the TV apparatus into a 3D processing state automatically.

In addition, the time cloud service server 411 sends an audio control signal and/or an audio signal corresponding to a scene. The DTV function block 14 of the TV apparatus can respond to the audio control signal and/or audio signal. Particularly when the scene information function and scene list function are in operation, the TV apparatus is in a reproduction situation differing from a situation where a normal program is reproduced continuously. Therefore, the audio system of the TV apparatus outputs music (e.g., BGM) or sound suitable for a scene.

Furthermore, it may be better to adjust the brightness or the color of an image according to a scene the user is watching. Even in such a case, the time cloud service server 411 can include image adjustment data in extended linkage data and transmit the resulting data according to the user or scene. For example, suppose a scene list has been requested in a situation where, for example, the information processing apparatus has logged in with a home login ID. Then, it is assumed that a specific scene (e.g., a scene of violence) is in a plurality of scenes specified by the scene list. In such a case, the time cloud service server 411 may include a control signal that causes the reproduction of the specific scene to be skipped in the extended linkage data and transmit the resulting data to a client.

The time cloud service server 411 can receive from the information processing apparatus not only the login identifier but also specification information including manufacturer information on, for example, the TV apparatus or mobile terminal and display capability and store them. The reason for this is that the display capability, control method, and the like of the TV apparatus may differ from maker to maker. When transmitting a control signal to the information processing apparatus (client) while the scene information function (Scenefo), scene list function (SceneList), or scene play function (ScenePlay) is operating, the time cloud service server 411 can transmit a control signal suitable for the client. In addition, when display data, such as a message created by the time cloud service server 411, is transmitted, the time cloud service server 411 may transmit in different languages, including Japanese, English, French, Korean, Chinese, German, and Spanish, and/or sounds according to the setting of the information processing apparatus (client).

Furthermore, the time cloud service server 411 is configured to transmit a power-saving instruction or a power-saving assistance request signal when a TV apparatus including an information processing apparatus (client) has a power-saving function. The time cloud service server 411 can receive a power demand situation and power forecast information from, for example, a power plant company. When the power supply quantity is getting tight with respect to the power consumption, the time cloud service server 411 can inform each information processing apparatus of power-saving assistance to achieve power saving.

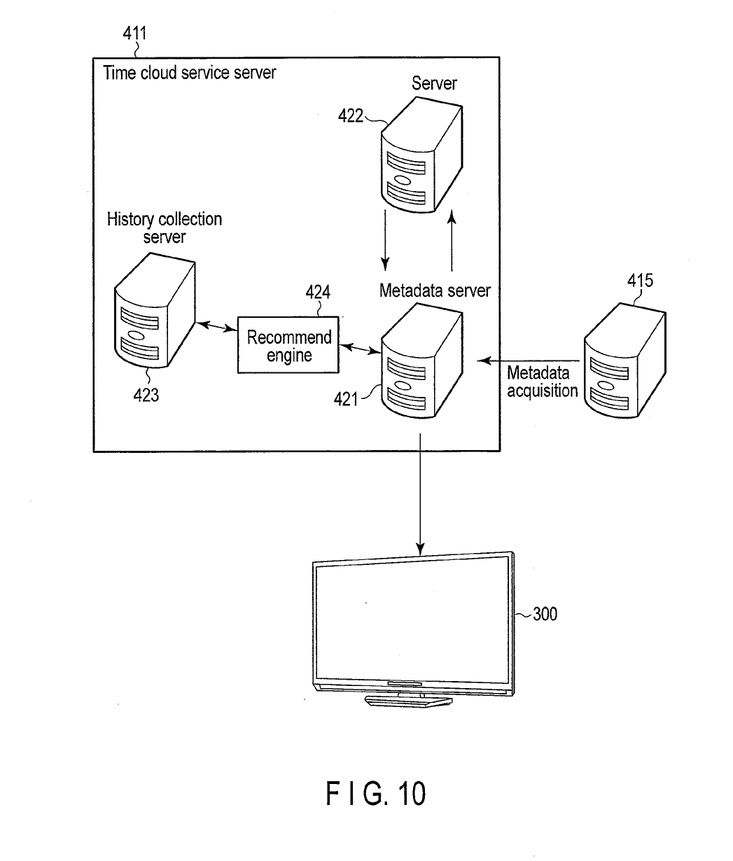

FIG. 10 shows an example of the organization of servers constituting the time cloud service server 411.

Numeral 421 indicates a metadata server. The metadata server 421 can receive various metadata items from a data creation server 415 in an outside data creation company. Metadata, which is program information, includes many pieces of information on programs, including broadcast channels, broadcast times, and performers. Metadata is used to create scene information, a tag list, a scene list, and the like at the metadata server 421. There is control information attached to a tag list, a scene list, and scene information.

In addition, the metadata server 421 can enter a tag list and/or a scene list into a tag list creation server 422. Moreover, the metadata server 421 can acquire a tag list and/or a scene list from the tag list creation server 422 at the request of a client (information processing apparatus) and provide it for the client (information processing apparatus). The metadata server 421 can create scene information using metadata and transmit it to the client (information processing apparatus).

The metadata server 421 collects, for example, curious scene information and recommended data from many clients (users) and transfers the collected data to a history collection server 423. The history collection server 423 takes statistics on program information on curious scene information and/or program information included in recommended data. By the statistical processing, a plurality of scenes specified a number of times in program information are ranked on a program basis. A plurality of scenes high in rank in a program are set as representative scenes and representative scene information corresponding to the representative scenes is created. By doing this, in each program, a plurality of representative scenes are determined. The representative scene information includes the name of a program, the broadcast date and time of the program, and a relative time until the reproduction of a representative scene is started when a program is reproduced from the beginning.

When a client has requested a scene play, the metadata server 421 can cause the server 423 to send back representative scene information on the requested program to the client.

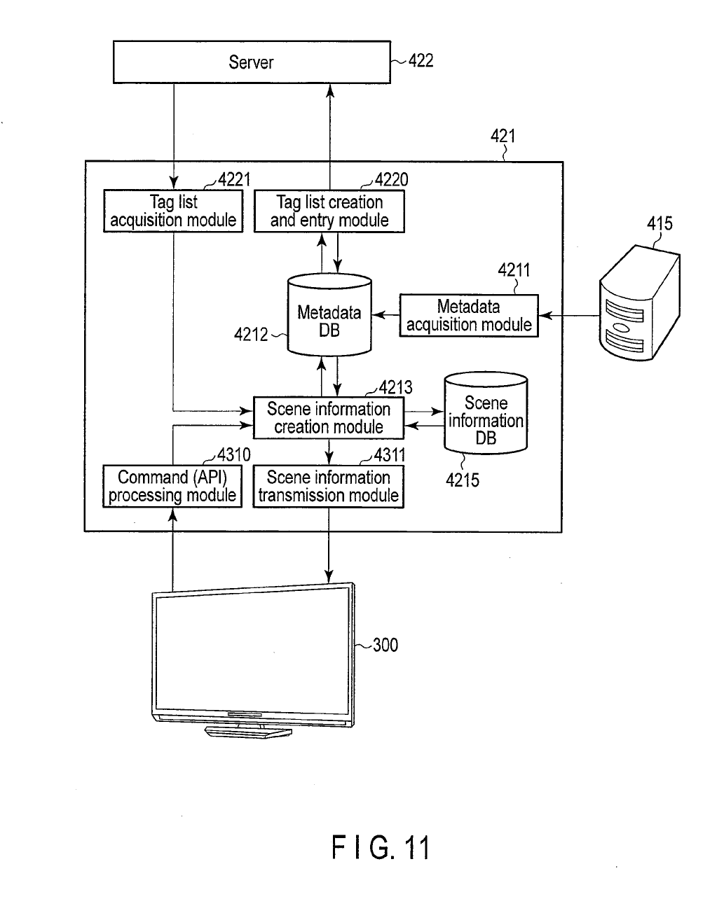

FIG. 11 shows an internal configuration of the metadata server 421. A metadata acquisition module 4211 receives various metadata items from the data creation server 415 and stores the metadata items in a database unit 4212. A tag list creation and entry module 4220 creates a tag list using metadata and enters the created tag list into the server 422. A tag list acquisition module 4221 can acquire a tag list from the tag list creation server 422 by request from a client (information processing apparatus) and provide the tag list to the client (information processing apparatus). A scene information creation module 4213 creates scene information using metadata and stores the crated scene information in a scene information database unit 4215. At the request of a client, an information transmission module 4311 transmits scene information and/or a tag list and/or a scene list to the client.

A command processing module 4310 receives an instruction and/or information from the client and reflects it in the operation of the metadata server 421.

The aforementioned blocks show only representative ones. The database unit 4212 stores various data items in addition to the above-described items. In addition, various control blocks are used to achieve operations described later.

The metadata server 421 performs information extended linkage processing. For example, when a client (user or information processing apparatus) has transmitted scene information on a curious scene to the metadata server 421 as described above, the metadata server 421 can transmit not only data corresponding to the request of the client but also the extended linkage data explained above. Therefore, the user obtains the convenience of being capable of using the extended linkage data effectively.

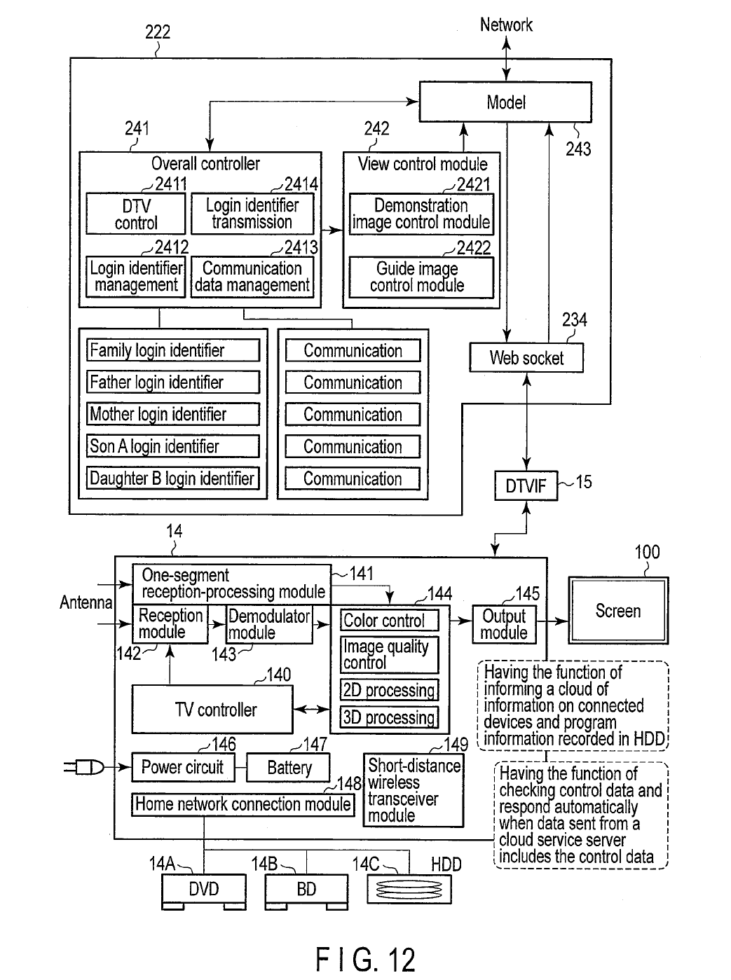

FIG. 12 shows a configuration of the information processing apparatus 222 and DTV function block 14 together with the relationship between them. The overall controller 241 includes a DTV control module 2411, a login identifier management module 2412, a communication data management module 2413, and a login identifier transmission module 2414. The DTV control module 2411 may control the DTV function block 14 on the basis of a user operation or control various TV function blocks 14 on the basis of control data from the time cloud service server 411. When a login identifier explained in FIGS. 3 and 4 has been input, the login identifier management module 2412 controls the storage of the login identifier and manages family and individual identifiers as table data. The communication data management module 2413 manages communication data so that the communication data items may correspond to the individual login identifiers. For example, when the user logged in has accessed an external server, the communication data management module 2413 manages its history data. The history data includes an access destination address, transaction data, and the like. The communication data management module 2413 can also classify and store data items sent from the cloud service server 411 and use the data as display data.

The login identifier transmission module 2414 transmits the logged-in login identifier to the cloud service server 411. The cloud service server 411 manages login identifiers from many users and uses them when providing guide images explained in FIG. 4.

The view control module 242 includes a demonstration image control module 2421 and a guide image control module 2422. This enables a demonstration image and a guide image as explained in FIGS. 1 to 4 to be provided for the DTV side.

The DTV function block 14 includes a one-segment reception-processing module 141 that receives a signal from an antenna, a reception module 142 that receives satellite broadcasting and terrestrial digital broadcasting, and a demodulator module 143. The reception module 142 and demodulator module 143, which include a plurality of tuners, can receive broadcast programs on a plurality of channels simultaneously and demodulate them. A plurality of demodulated program signals can be converted into a DVD format at a DVD device 14A and recorded onto a digital versatile disc. Alternatively, the demodulated program signals can be converted into a BD format at a BD device 14B and recorded onto a Blu-ray disc. Moreover, in any stream, the demodulated program signals can be recorded onto a hard disk with a hard disk drive 14C. The DVD device 14A, BD device 14B, and hard disk drive 14C are connected to the DTV function block 14 via a home network connection module 148. The hard disk drive 14C may be of a type to be connected via a USB cable. The hard disk drive 14C may be based on a method capable of recording all the programs on a plurality of channels (e.g., set six channels) simultaneously for, for example, about one to three weeks. This type of function may be referred to as a time shift function. In addition, the DTV function block 14 may be configured to include more hard disk drives.

The network connection device and recorded program information can be grasped by a TV controller 140 and transmitted to the cloud service server 411 via the information processing apparatus. In this case, the time cloud service server 411 can grasp the user's home network connection device and recorded program information. Therefore, when each scene is reproduced on the basis of scene list information, the cloud service server 411 can specify even a home connection device in which the various scenes have been recorded.

A program signal demodulated in the DTV function block 14 or a program signal reproduced from a recording medium, such as a DVD, a BD, or an HD (hard disk), is subjected to various adjustments (including brightness adjustment and color adjustment) at a signal processing module 144 and is output to the screen 100 of the display module via an output module 145.

The DTV function block 14 includes a power circuit 146. The power circuit 146 can switch between a use situation of commercial power and a use situation of a battery 147 as needed. The switching between the use situations includes a case where the user performs the switching forcibly by operating the remote controller and a case where the switching is performed automatically on the basis of external information.

The cloud service server 411 can transmit a control signal to bring the TV apparatus into a 3D processing state automatically. Furthermore, the cloud service server 411 can transmit an audio control signal and/or an audio signal corresponding to a scene to the TV apparatus. Moreover, according to a scene, the cloud service server 411 can include image adjustment data in extended linkage data and transmit the resulting data.

The DTV function block 14 includes a short-distance wireless transceiver module 149. The DTV function block 14 can transmit and receive data to and from a mobile terminal via the short-distance wireless transceiver module 149. The mobile terminal can request an operation image from the DTV function block 14. When the DTV function block 14 has been requested to give an operation image, it can transmit a guide image as shown in FIGS. 3 and 4 to the mobile terminal. The user can control the information processing apparatus making use of the guide image on the mobile terminal.

The DTV function block 14 can check control data sent from the cloud service server 411 and reflect the data in an operation state automatically.

Therefore, with the system, the information processing apparatus basically transmits data (control signal corresponding to a scene information key, a scene list key, and a scene play key) acting as a trigger to a server via the network connection module in response to a first operation signal from the user. Next, the information processing apparatus acquires extended linkage data sent back on the basis of the trigger data, classifies a first control signal (instruction) for automatic control included in the extended linkage data and a second control signal (instruction) corresponding to the second operation signal from the user, and stores them. They are stored in the overall controller or model. Then, the information processing apparatus can perform an autonomic operation on the basis of the first control signal (instruction) and/or a heteronomous operation on the basis of the second control signal (instruction). The autonomic operation means operating in an autonomic manner. For example, this means obtaining a display image in the area 106 as shown in FIG. 4 or controlling the DTV function block 14. The heteronomous operation means waiting for a user operation and responding to a second operation signal when the second operation signal from the user is input. This operation includes the operation of responding to merchandise selection, the operation of responding to tag list selection, and the operation of responding to scene list selection as shown in FIGS. 6, 7, and 8. The extended linkage data further includes display data to be displayed. The display data includes various messages and albums. When having received a power-saving instruction from the time cloud service server 411, the DTV function block 14 can perform a power-saving operation. The power-saving operation includes, for example, the change of a full-segment reception state to a one-segment reception state, the reduction of the display area of the display module, and the change of commercial power use to battery use.

In addition, in the screen shown in FIGS. 1-4, the DTV function block 14 can control the brightness of an area of a moving image in the area 101 so that the brightness may be higher than that of another area. That is, the DTV function block 14 can make the brightness of a guide image in the area 102-104 lower than that of a moving image in the area 101, thereby making the moving image easily viewable. To perform a specific operation, the DTV function block 14 can control the brightness of a guide image pointed to by the cursor so that the guide image may get brighter.

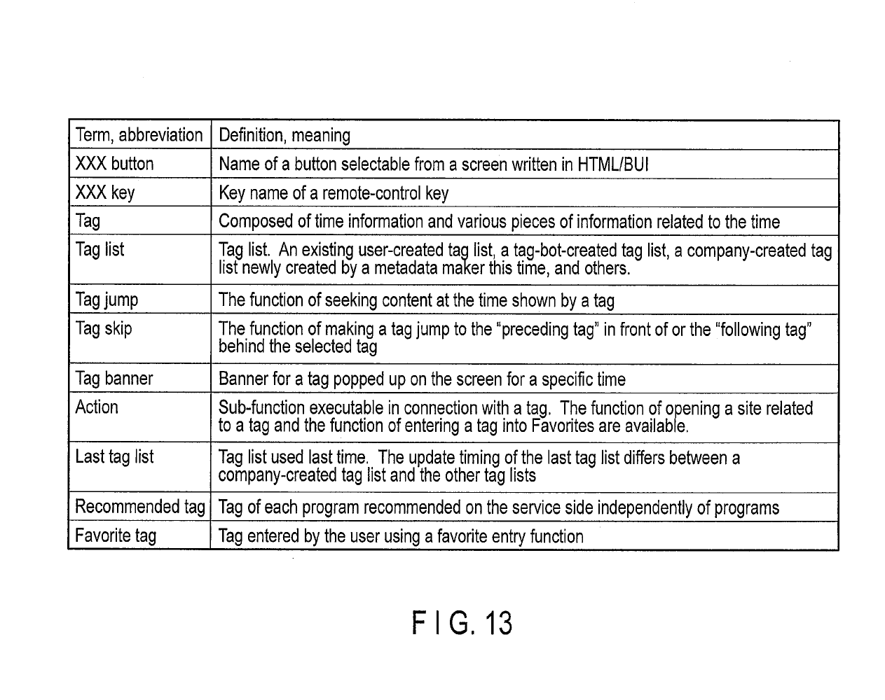

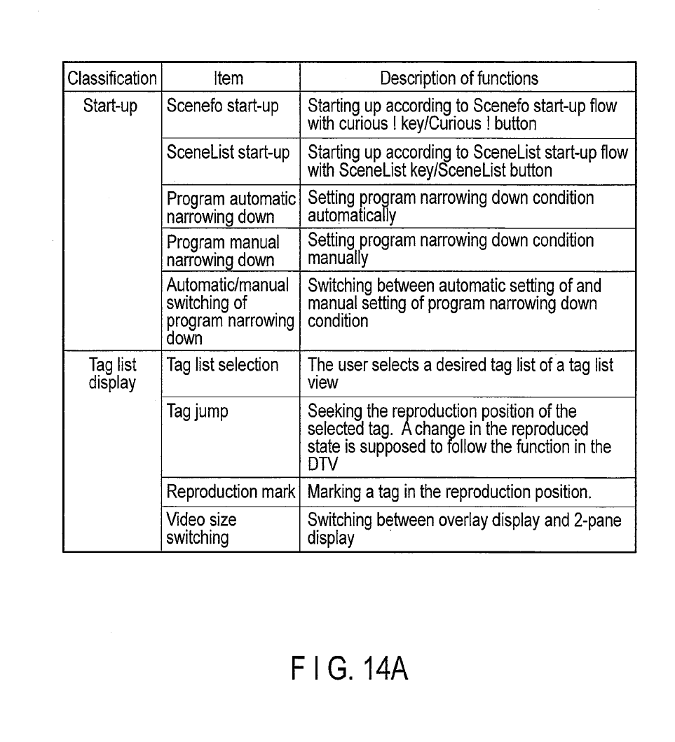

FIG. 13 shows an example of the definitions of terms when the embodiment has been applied to a digital television receiving apparatus. The terms are not restricted to what have been defined here.

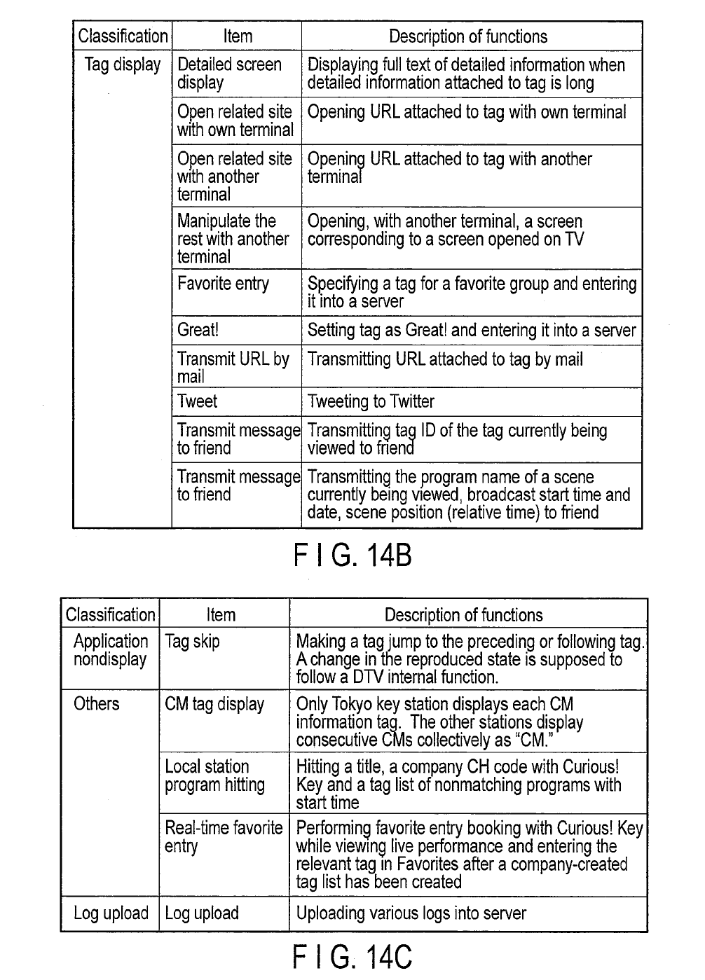

FIGS. 14A, 14B, and 14C, which have already been explained, show an example of the functions of Scenefo and SceneList in list form.

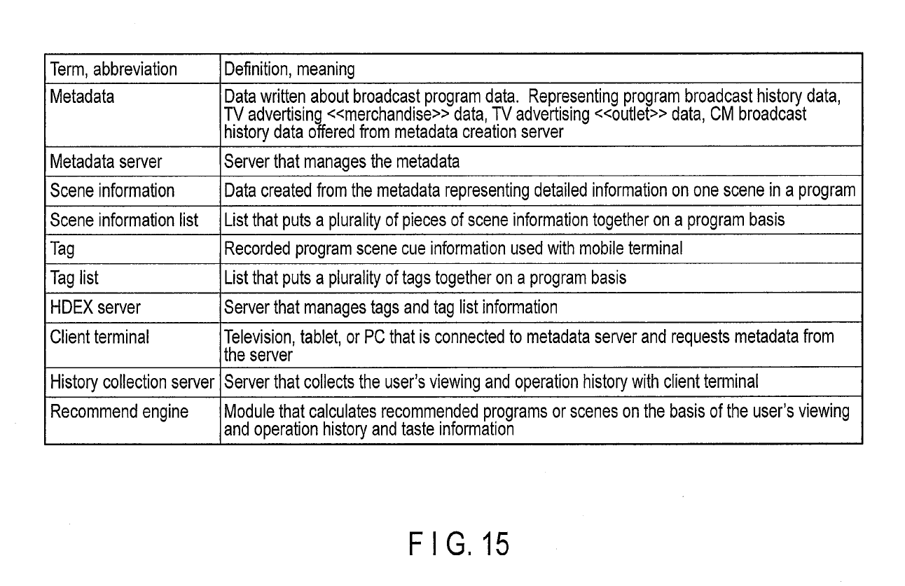

FIG. 15, which has already been explained, shows the meanings of terms used mainly on the time cloud service server 411 side in list form.

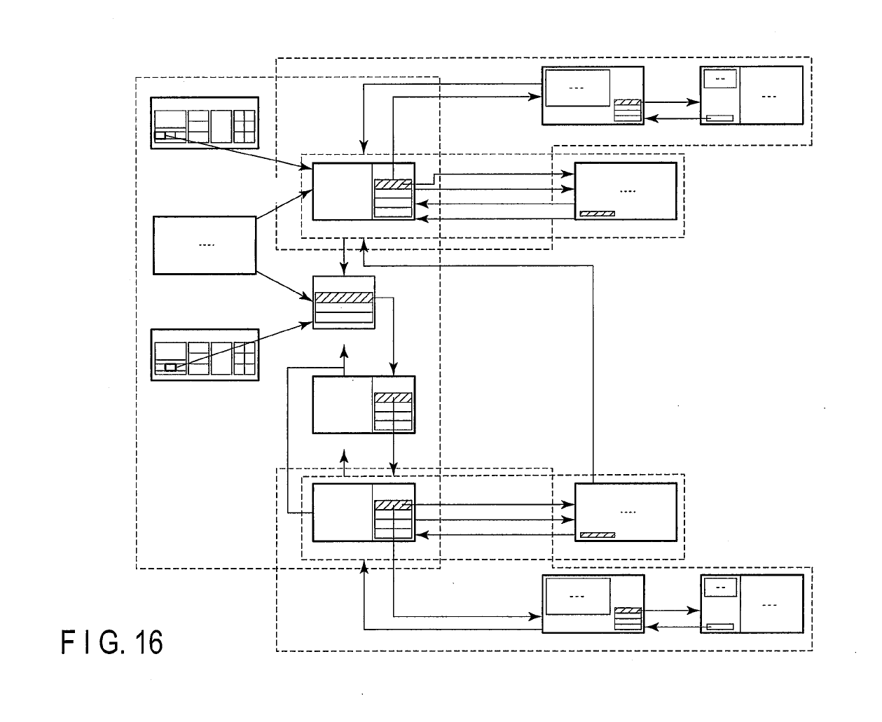

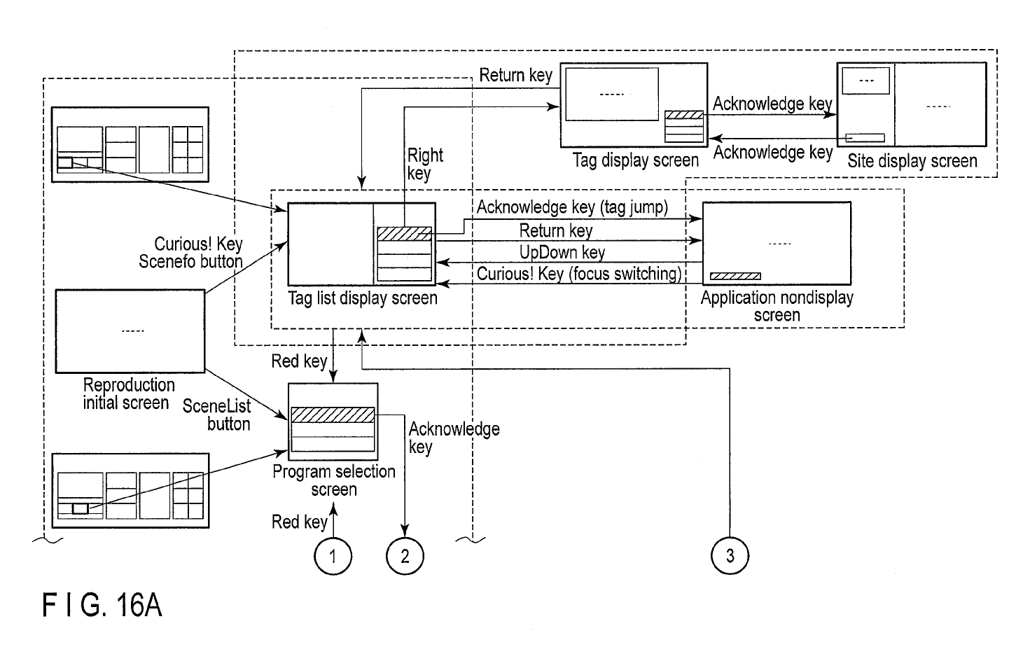

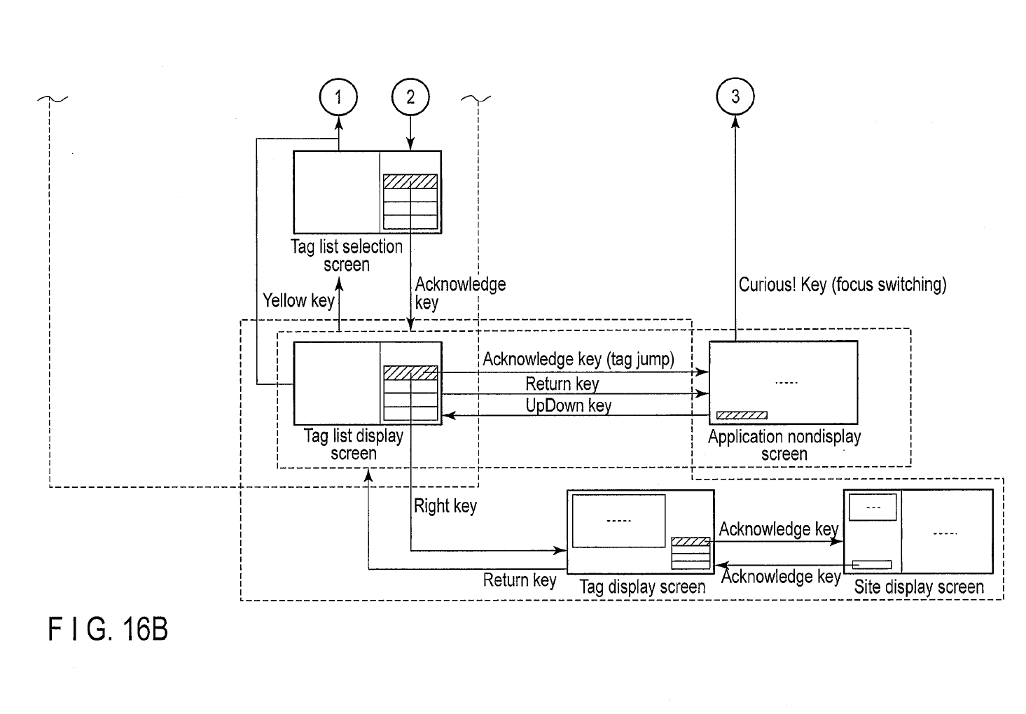

FIG. 16, FIG. 16A and FIG. 16B show an example of the transition of screens related to Scenefo/SceneList. With the DTV, when video content has been reproduced (on a reproduce initial screen), a Scenefo/SceneList application has not been activated. The Scenefo/SceneList application is started by a user operation. At this time, a browser is also started at the same time the application is started.

For example, the “Scene information key” (also referred to as “Scenefo” key) on the remote controller is operated. Or, the “Curiousity key” may be operated. Or, when the cloud service server 411 is in the service mode, a small screen of the scene information button can be selected. Then, a tag list about a program currently being reproduced is displayed on the screen. Here, when the user has selected a desired tag list and pressed the acknowledge button, program reproduction is performed on the basis of the tag list. In addition, when the “Scene list key or quick key” or the “Scene list button” on the remote controller or on the screen has been operated, control proceeds to a scene list selection screen.

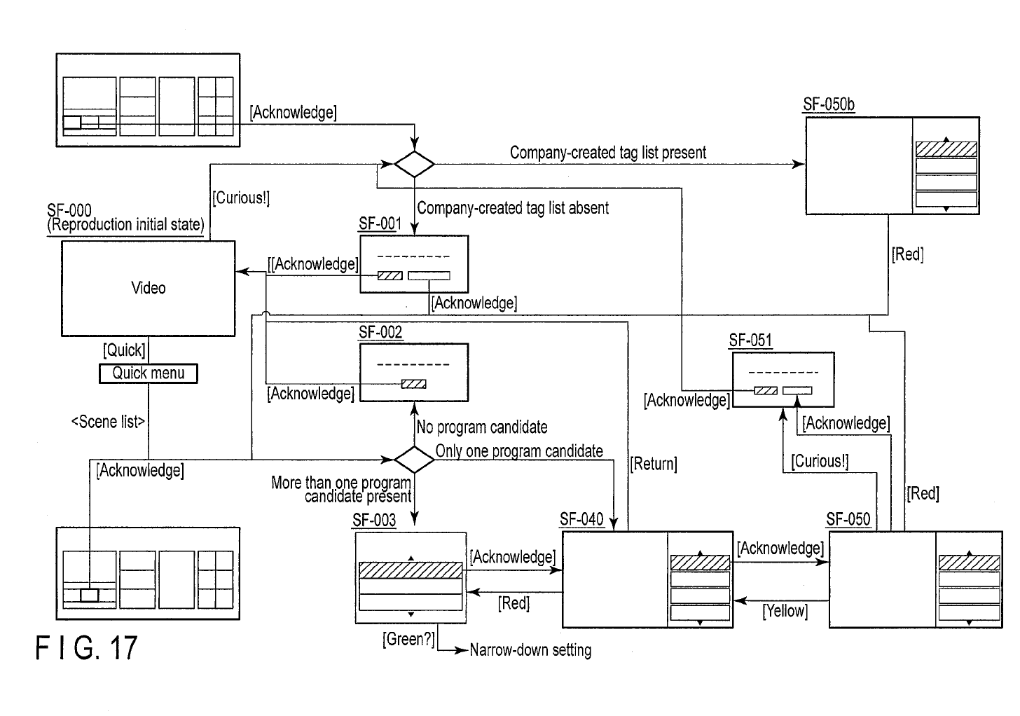

FIG. 17 shows an example of the transition of operations at the time of the start of the application. When a tag list is displayed, or when a scene list is displayed, it is determined whether there is a list. If there is a list, it is further determined whether there is more than one list. The user selects a desired one from a tag list or a scene list and operates the acknowledge button. This causes image reproduction to be started on the basis of the tag list or scene list. Moreover, on the basis of scene information sent from the cloud service server, the user can go into a browsing state of a merchandise sale site, an outlet site, or the like. In the screen transition diagram, colors, including [Yellow], [Red], and [Green], are written. These mean the colors of the keys on the remote controller. In addition, [Left] and [Right] are written. These indicate the cursor moving keys. They can be used to give a jump instruction, depending on the state of the screen.

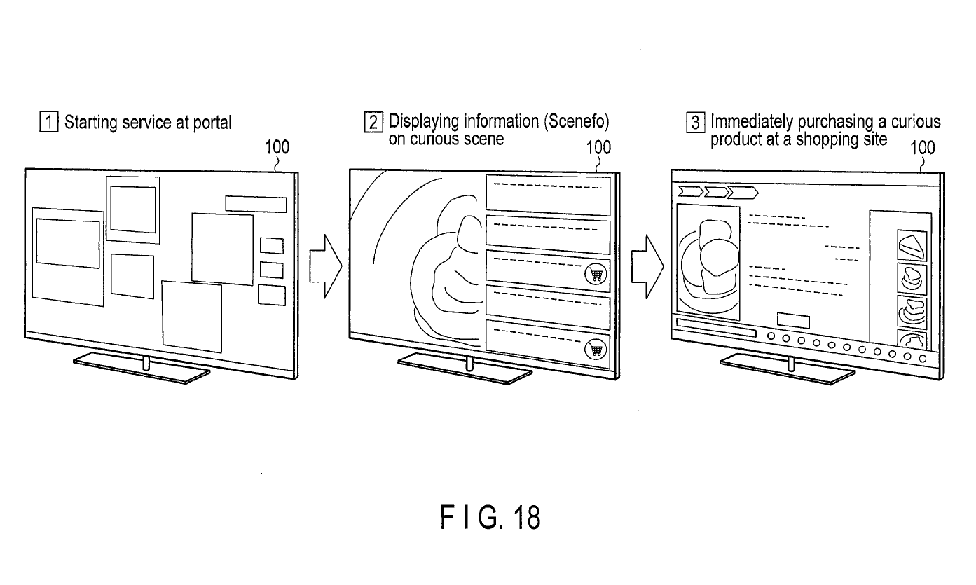

As shown in FIG. 18, the embodiment enables the user to start a service at a portal and display curious scene information or immediately purchase a curious product at a shopping site.

As described above, with the system of the embodiment, related information suitable for a scene can be presented in a timely fashion for each detailed scene.

Next, an operation in the embodiment will be explained. An operation mode can be developed variously and therefore is not limited to an example explained below.

When the DTV has detected that the [Scenefo] key has been pressed while content of a PVR or a time shift machine is being reproduced, the DTV displays a list of Scenefo (Scenefo list), focusing on the nearest neighboring Scenefo in front of the present reproduction position. The list display may be realized by using another input replacing the [Scenefo] key as a trigger. The time shift machine is a device that records (or records all the) broadcast contents on a plurality of channels (e.g., six channels) for a specific period of time before the present (e.g., the past 15 days). When the time shift machine has recorded all the broadcast contents, the user can view the programs broadcast in the past (e.g., for the past 15 days) at any time.

For example, in a Scenefo list (scene information list), a part (about two lines) of Scenefo is displayed in list form.

When there is no Scenefo, the dialogue “Scenefo is not found. Do you want SceneList displayed?” is displayed. If Yes, control proceeds to a SceneList selection screen.

When having detected that [Up] or [Down] key has been pressed while the Scenefo list is being displayed, the DTV moves the cursor to Scenefo.

When having detected that the [Acknowledge] key has been pressed with the cursor hitting against any Scenefo, the DTV reproduces a scene corresponding to the Scenefo hit by the cursor (reproduce jump).

When having detected that the [Return] or [End] key has been pressed while the Scenefo list is being displayed, the DTV closes the Scenefo list.

When having detected that [Right] key has been pressed with the cursor hitting against any Scenefo while the Scenefo list is being displayed, the DTV displays detailed information on Scenefo. Detailed information on Scenefo includes all of Scenefo. The detailed information on Scenefo includes action buttons corresponding to the contents of Scenefo.

For example, the detailed information includes action buttons corresponding to the following functions:

“Enter this scene into Favorites”

“Great!”/“Cancel Great!”/“Great! with a count”

“Open a shopping site on TV”

“Open a shopping site with application”

“Transmit this Scenefo by mail”

When having detected that the “Enter this scene into Favorites” key has been pressed, the DTV enters a corresponding scene in Favorites (this can be used in a case where the user wants to do bulk buying later or view this scene again later).

The cloud service server can manage a favorite Scenefo for shared usage with TV/applications or the like.

When the “Great!” button has been pressed, the DTV causes a log representing Great! to correspond to Scenefo and uploads the resulting log to a server. As a result, the count of Great! caused to correspond to Scenefo increases.

When having detected that the “Open a shopping site on TV” button has been pressed, the DTV opens a shopping site with the browser.

When having detected that the “Open a shopping site on application” button has been pressed, the DTV gives the URL of the shopping site to the application. The application opens the shopping site on the basis of the URL.

When having detected that the “Transmit this Scenefo by mail” button has been pressed, the DTV displays a destination mail address selection screen. The destination mail address selection screen can present mail addresses set in a mail booking or the like as candidates and accept the selection of a mail address. When the user has selected a mail address and pressed the “Transmit” button, the DTV detects that a mail address has been selected and the [Transmit] button has been pressed and transmits a mail.

When having detected that a switching button has been pressed while the Scenefo list is being displayed or the details of Scenefo are being displayed, the DTV can switch between “Full image+overlay Scenefo” representation and “Image and Scenefo division” representation.

When having detected that the [Left] or [Right] key has been pressed while content is being reproduced, the DTV can make a reproduce jump [in front of] or [behind] Scenefo or SceneList.

The DTV operates on the basis of what has been used last (a specific list of Scenefo or SceneList). In a default setting, the DTV operates on the basis of Scenefo. When there is no Scenefo and SceneList has never been used while the content is being reproduced, the DTV does nothing.

When having detected that the [SceneList use] button has been pressed while the Scenefo list is being displayed, the DTV can move to a SceneList selection screen.

For example, the DTV enables Scenefo to be used as one of the tag lists from the existing “Tag list use.”

In addition, the DTV can display some tag lists, such as only CM or only merchandize information, from one Scenefo.

When having detected that the [Scenefo] button has been pressed, the DTV can display detailed information on the nearest neighbor Scenefo in front of the present reproduction position.

The DTV always displays the nearest neighbor Scenefo in front of the present reproduction position.

When having detected that the “Open a shopping site with application” button has been pressed, the DTV receives the URL of the shopping site and opens the shopping site with the browser in the application.

When having detected that “Favorite Scenefo” button has been pressed, the DTV displays a favorite list and opens the shopping site in response to the act of “Open a shopping site” or the like.

<Related Log Upload Requirements>

DTV:

When having detected that the [Scenefo] key has been pressed in a normal mode, the DTV can upload the (Scenefo mode start) reproduction position at which the Scenefo list has been displayed and Scenefo.

The DTV can upload Scenefo used to make a scene jump from the Scenefo list in response to the detection of the [Acknlowledge] key being pressed.

The DTV can upload Scenefo used to display the details of Scenefo from the Scenefo list in response to the detection of [Right] key being pressed.

The DTV can upload the URLs or the like of purchase sites, merchandise sites, outlet sites, or map sites obtained from the details of Scenefo.

The DTV can upload Scenefo corresponding to the details of Scenefo when having transferred the details of Scenefo to the application.

The DTV can upload Scenefo corresponding to the details of Scenefo when having transferred the details of Scenefo by mail.

The DTV can upload Scenefo for which “Great!” has been specified.

The DTV can upload Scenefo entered into

Favorites.

Terminal:

When having displayed Scenefo as a result of [Scenefo] key being pressed, a terminal can upload the reproduction position of Scenefo and Scenefo.

The terminal can upload the URLs or the like of purchase sites, merchandise sites, outlet sites, or map sites obtained from the details of Scenefo.

The terminal can upload Scenefo corresponding to the details of Scenefo when having transferred the details of Scenefo by mail.

The terminal can upload Scenefo for which “Great!” has been specified.

The terminal can upload Scenefo entered into Favorites.

The terminal can upload a tag list use log treating Scenefo as one of the tag lists.

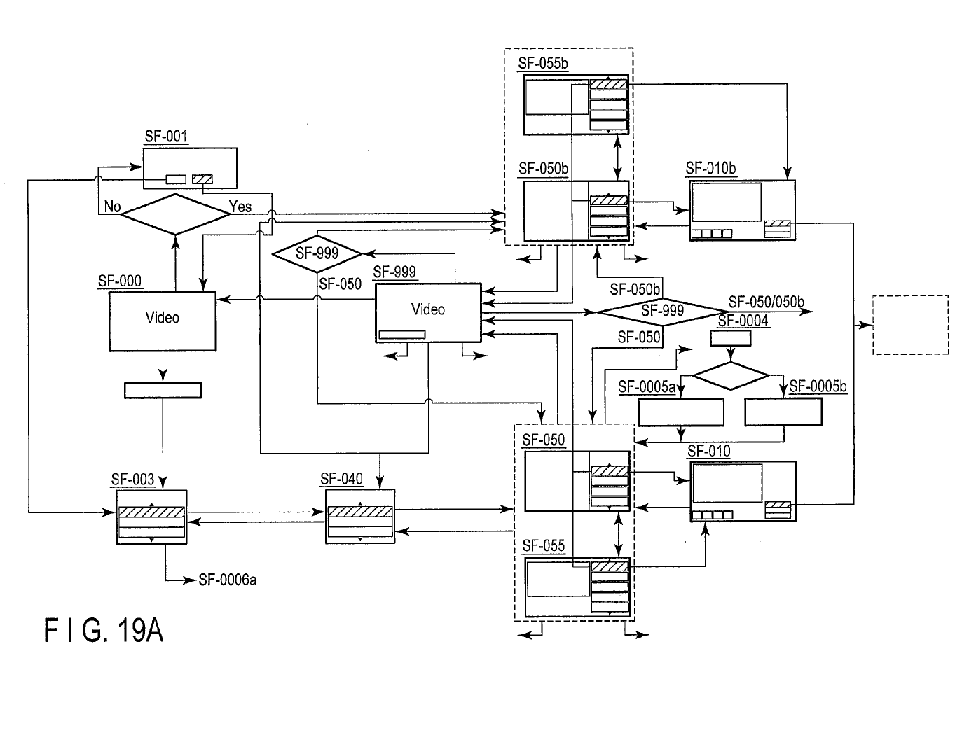

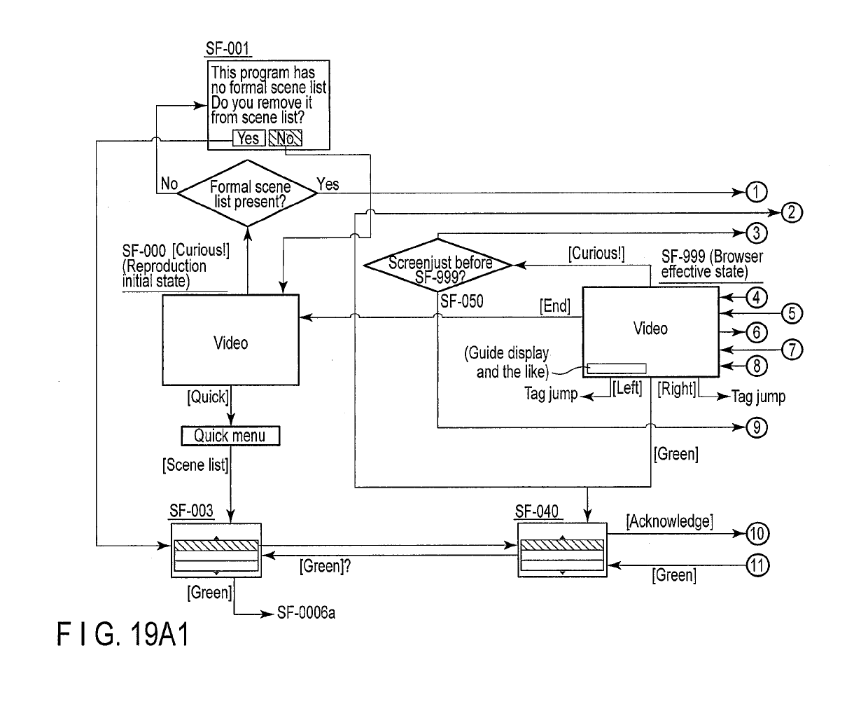

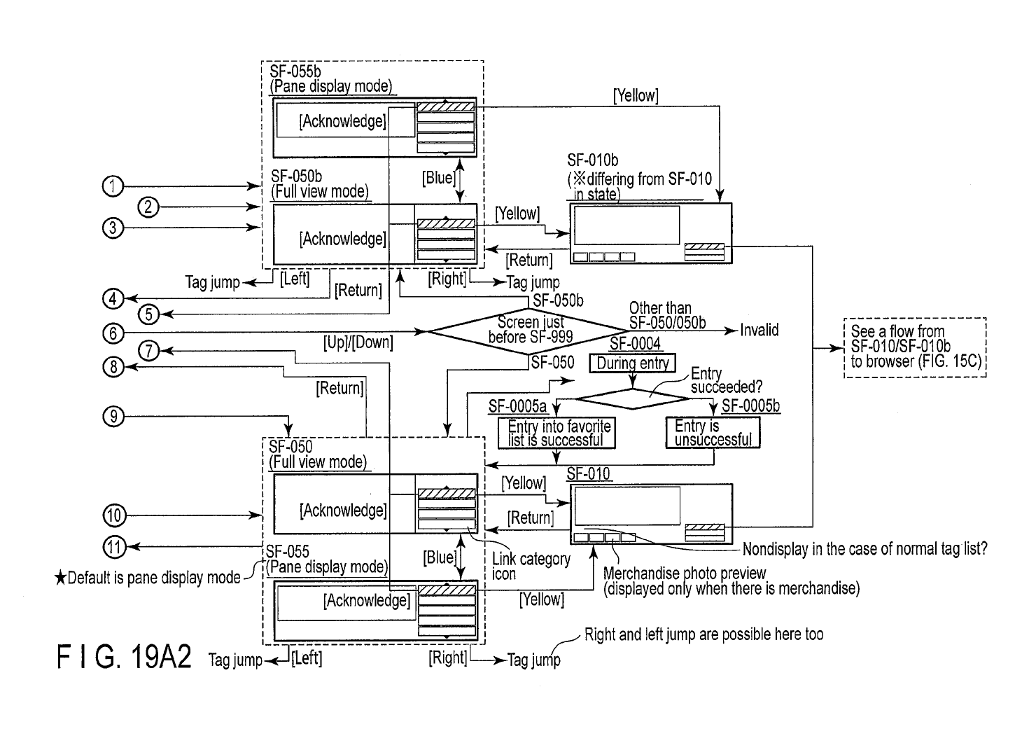

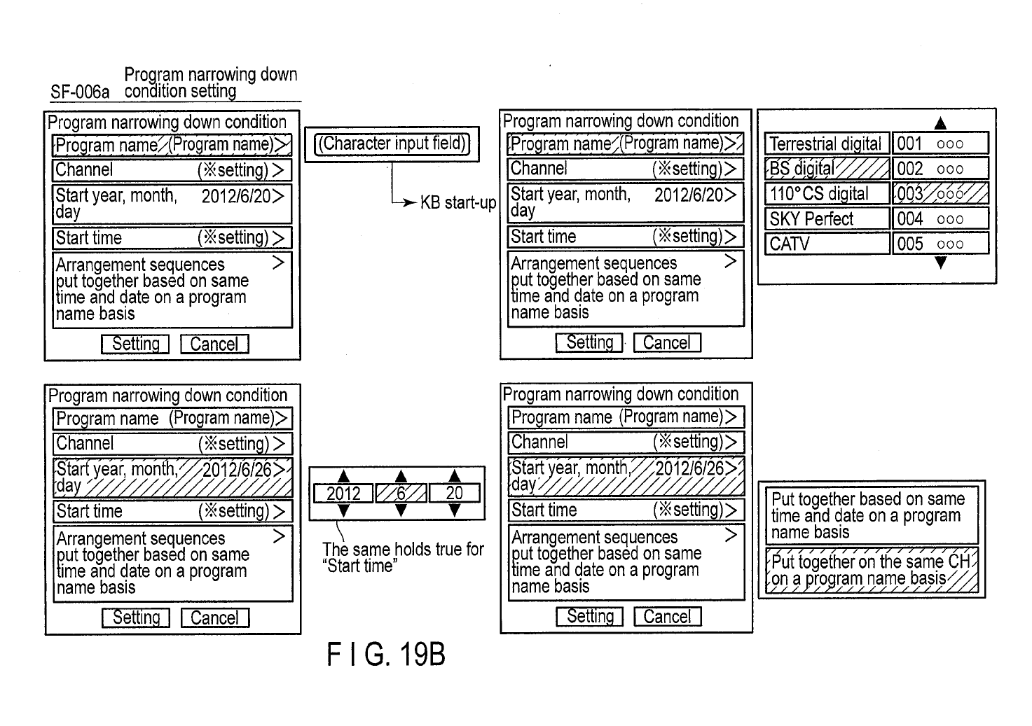

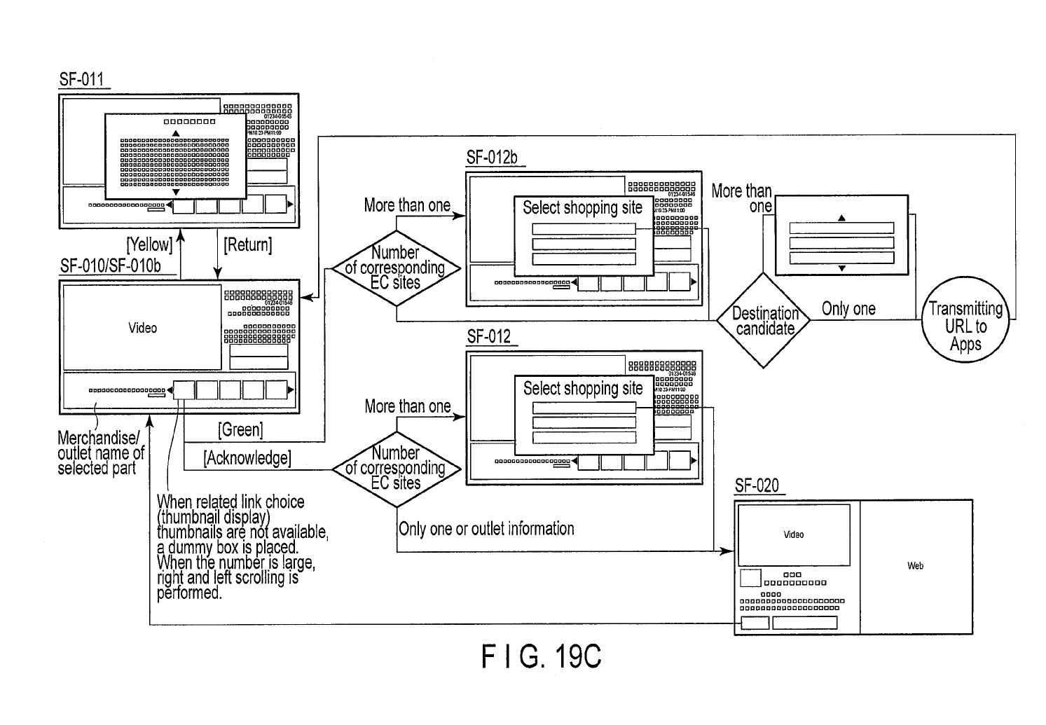

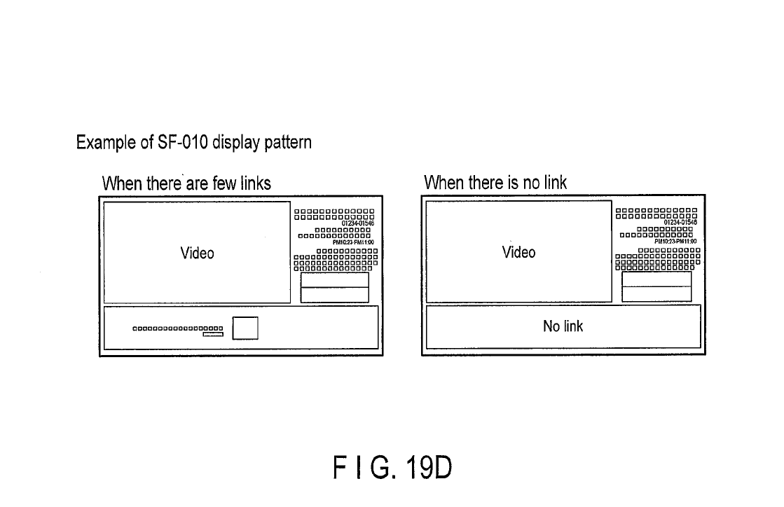

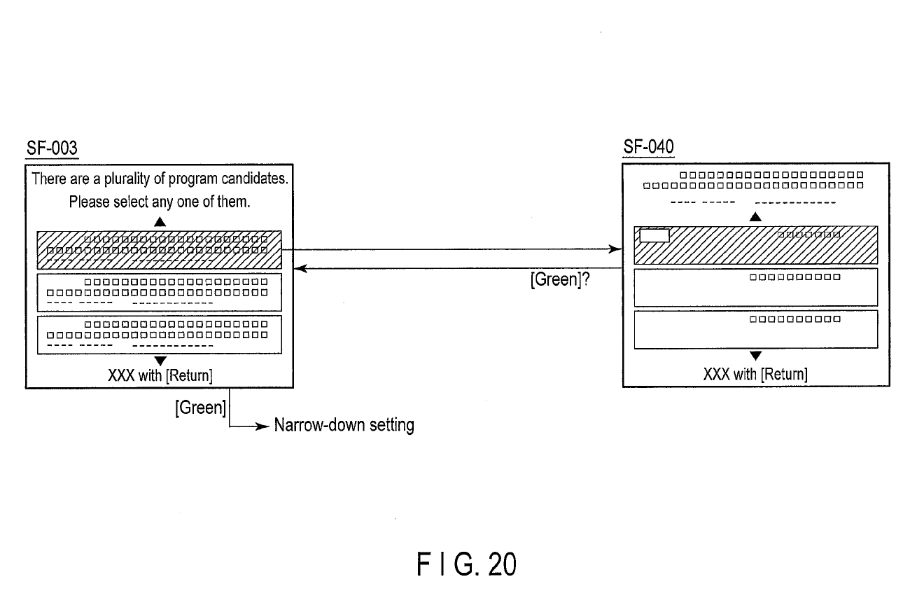

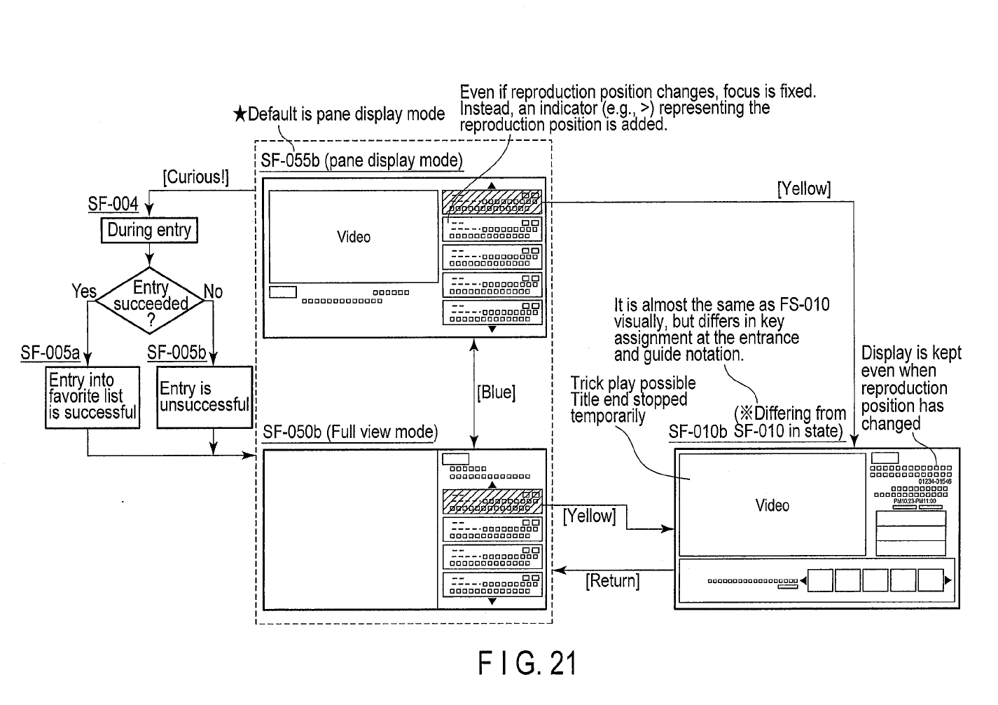

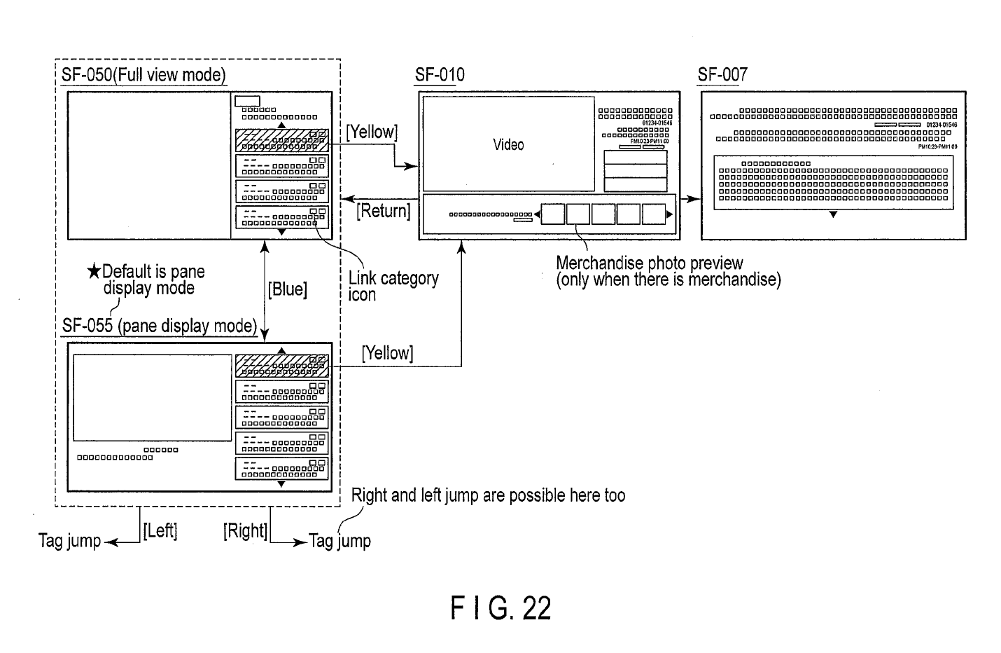

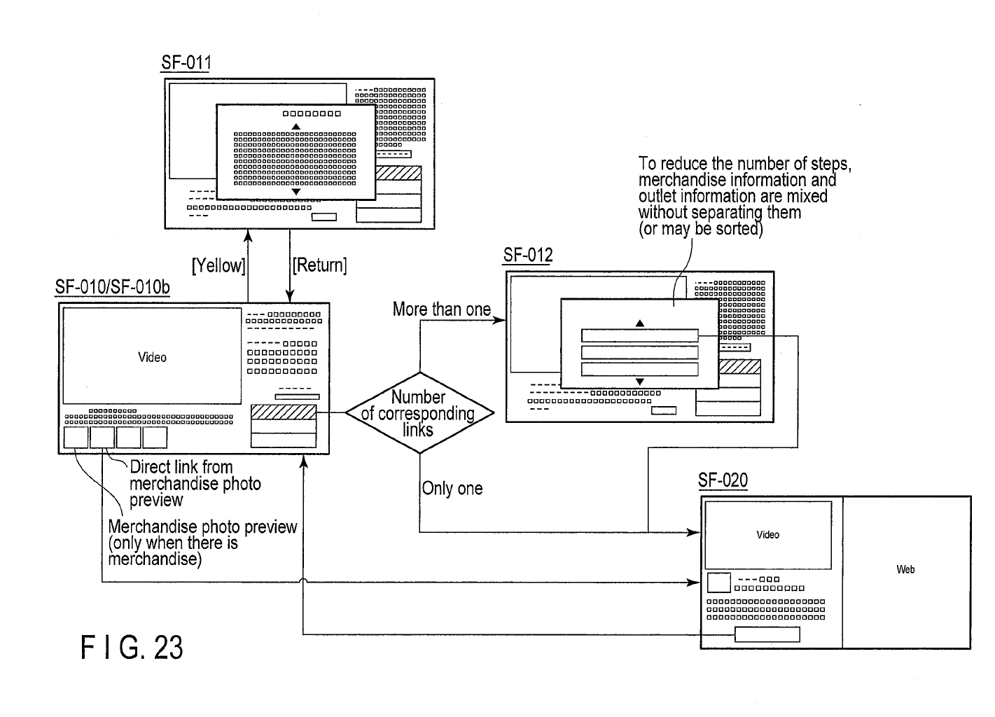

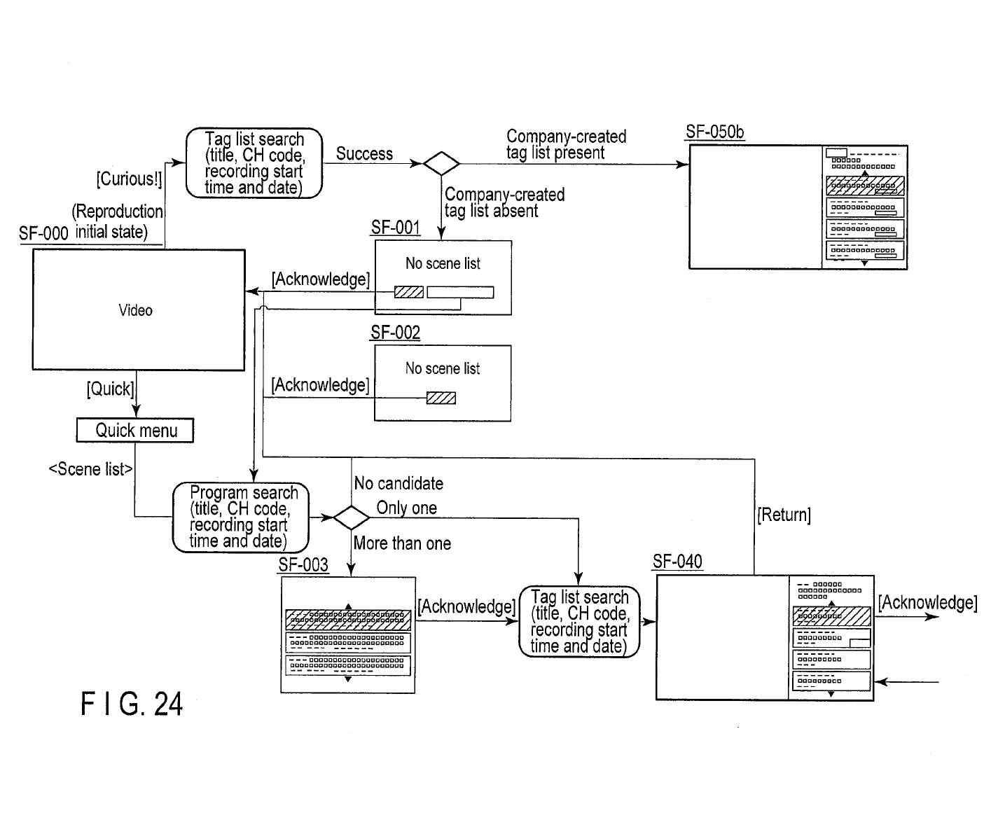

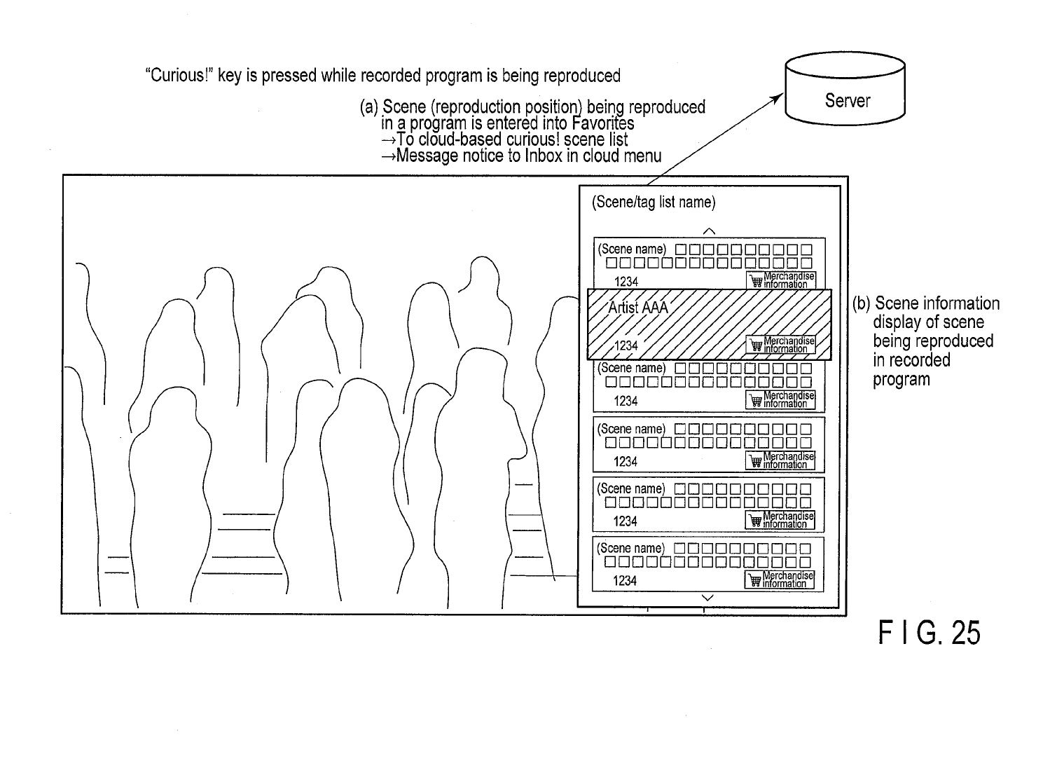

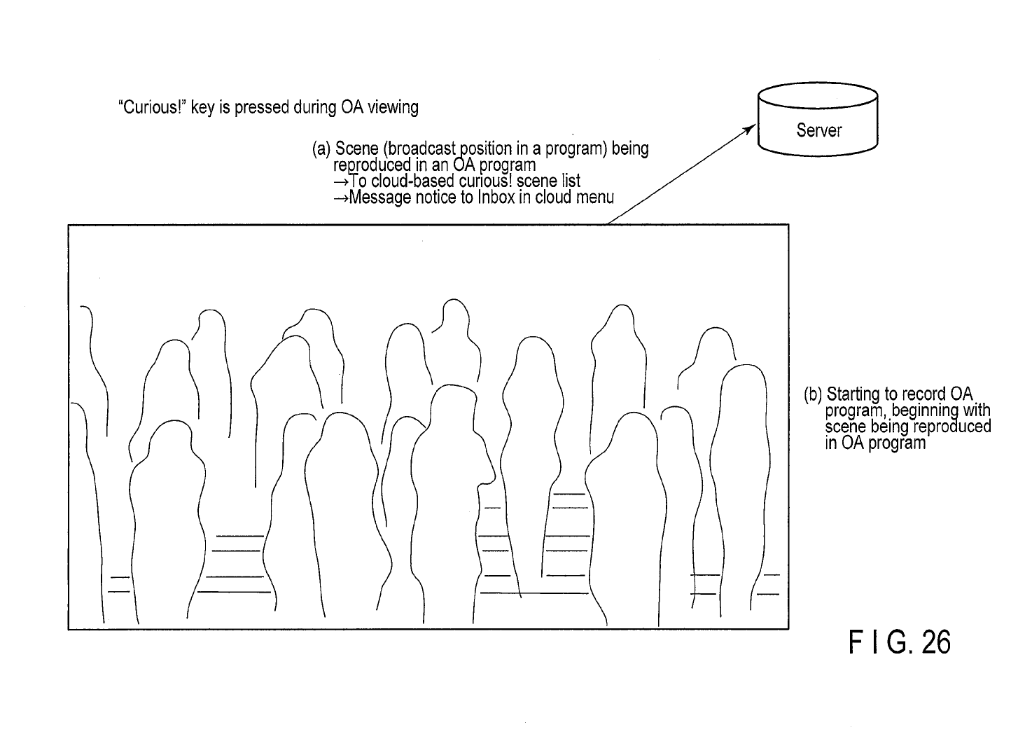

Next, an example of screen transition will be explained. FIGS. 19A, 19A1, 19A2, 19B, 19C, and 19D show an example of screen transition. FIGS. 20 to 24 show an example of the details of screen transition. FIGS. 25 to 28 each show an example of a screen.

For example, in a state where the DTV is displaying, for example, a recorded content (a recorded program) reproducing screen in a reproduction initial state or a browser initial state (SF-000/SF-999 in FIGS. 19A, 19A1 and 19A2), when the DTV has detected that the “Curious!” key has been pressed, the DTV displays scene information being reproduced, scene information after reproduction, and scene information before reproduction in list form.

FIG. 25 shows a list representation of scene information. When having detected that the “Curious!” key has been pressed while recorded content (a recorded program) is being reproduced, the DTV enters, for example, a scene currently being reproduced (reproduction position) into Favorites and further into a cloud-based curious! scene list and informs the Inbox of the cloud menu of a message. In addition, the DTV displays a plurality of pieces of scene information (scene information currently being reproduced, scene information after reproduction, and scene information before reproduction) in list form. Scene information includes merchandise information icons and the like. The user can view a merchandise information site or a merchandise purchase site according to a scene by just selecting a merchandise information icon.

In a state where the DTV is displaying, for example, a broadcast content (an OA program) reproducing screen (real-time reproducing screen) in a reproduction initial state or a browser initial state (SF-000/SF-999 in FIG. 19A), when the DTV has detected that the “Curious!” key has been pressed, the DTV1 enters, for example, a scene (broadcast position) currently being reproduced into a cloud-based curious! scene list and informs the Inbox of the cloud menu of a message. In addition, the DTV1 starts to record a scene currently being reproduced.

As described above, the processes based on the depression of “Curious!” key are switched according to a reproducing situation. That is, when having detected that the “Curious!” key has been pressed while recorded content is being reproduced, the DTV displays scene information. When having detected that the “Curious!” key has been pressed while broadcast content is being reproduced, the DTV starts recording.

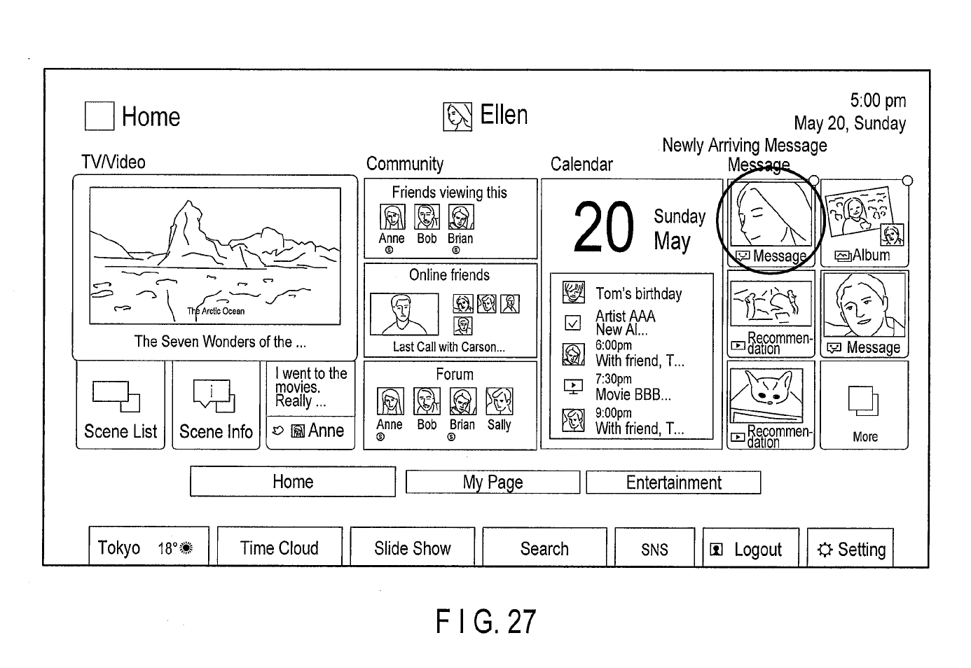

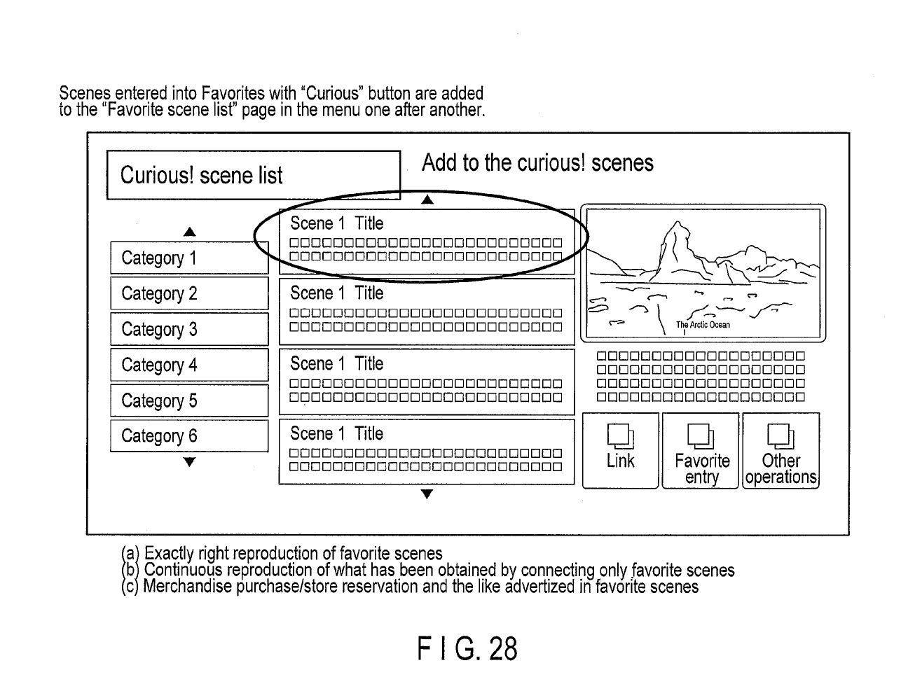

FIG. 27 shows a cloud menu displayed by the DTV. The notice of the message is reflected on the message icon. In addition, the scene list icon can be selected and displayed on a scene list screen of FIG. 28. That is, the entered scene information can be selected from the scene list screen. For example, when the user has selected desired entered scene information, the DTV reproduces a scene corresponding to the selected desired entered scene information. In addition, when the user has selected continuous reproduction on the basis of a plurality of pieces of entered scene information, the DTV links a plurality of scenes corresponding to a plurality of pieces of entered scene information and reproduces the linked scenes continuously. Moreover, when the user has selected a merchandise icon, a shopping icon, or the like included in entered scene information, the DTV displays a merchandise information site, a merchandise purchase site, a shopping site, or the like.

Hereinafter, an example of the recommended specification of a time cloud is shown.

<Recommended Scenes>
Highly recommended scene

A time slot with a high rating is calculated on the basis of a viewing log and scenes of the corresponding data are set as scenes with a high rating. Of the scenes, one in a program recorded by the user is recommended.
Popular scene

Tag scenes with many tag jumps are calculated on the basis of a tag jump log in a time cloud. Of the tag scenes, one in a program recorded by the user is recommended.
Everyone's curious scene

Scene tags frequently bookmarked are calculated on the basis of scene tags entered into Favorites by time cloud users. Of the scene tags, one in a program recorded by the user is recommended.
Twitter lively scene

A time slot with a large number of tweets is calculated on the basis of tweets to a broadcast station hash tag. A scene managed by a corresponding metadata creation server is recommended as a lively scene.
Friend's recommended scene

A scene transmitted by a friend using “Message transmission to a friend” is recommended.
User's recommended scene list

A scene list created by the user collecting the user's favorite tag scenes is presented.
Friend viewing scene

A tag scene with many tag jumps is calculated on the basis of a friend's log of tag jumps. The tag scene is recommended.
Popular merchandise and outlet scene

The number of jumps to purchase sites is tallied. Purchase sites (merchandise) with a large number of jumps are recommended. The number of jumps to outlet sites (outlets) is tallied. Outlet sites with a large number of jumps are recommended.
Recommended scenes for you

Personalized recommendation. Scenes suiting the user's taste are calculated on the basis of other users' profile-viewing scene logs. Of the scenes, one in a program recorded by the user is recommended.

All of the procedures for the above processes can be realized with software (a scene information output program). Therefore, the processes can be realized by just installing a program (an application) for executing the processing procedure into a client terminal or a mobile terminal and running the program.

For example, the client terminal or mobile terminal can download the program from a server, store the downloaded program, and complete the installation of the program. Alternatively, the client terminal or mobile terminal can read the program from a computer-readable storage medium, store the read program, and complete the installation of the program.

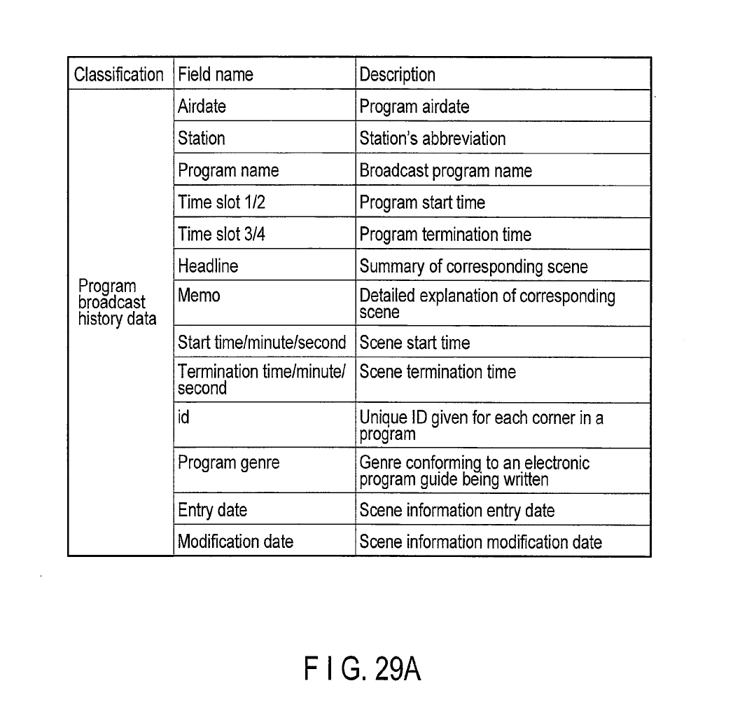

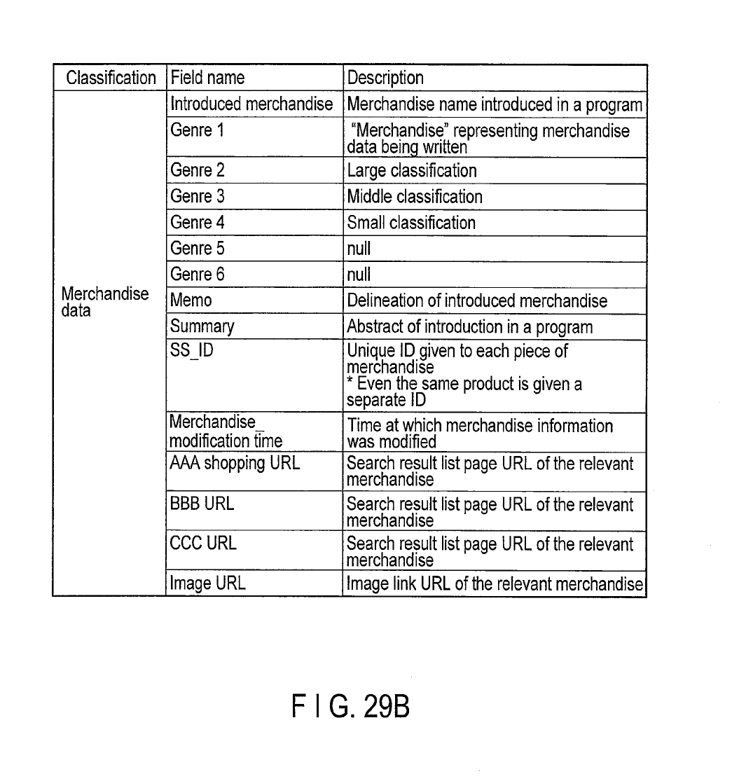

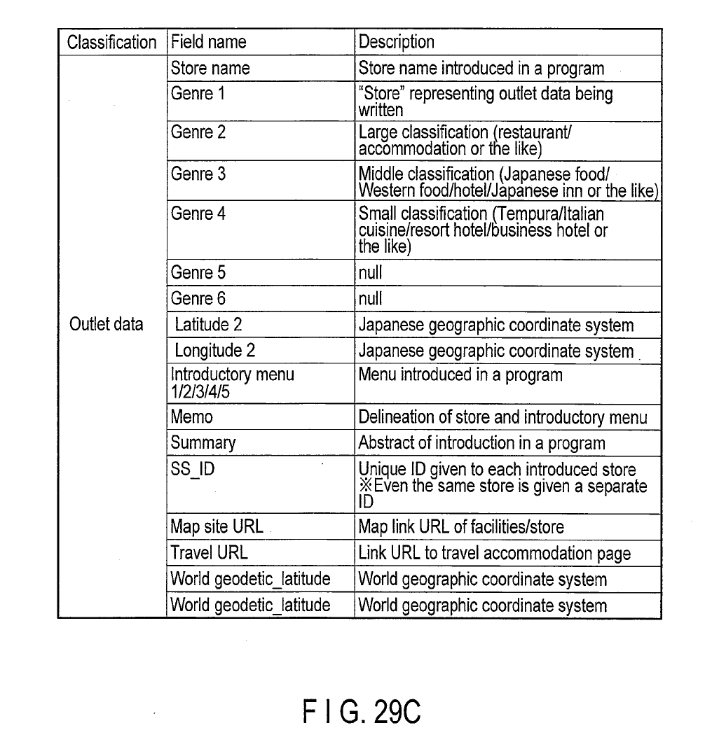

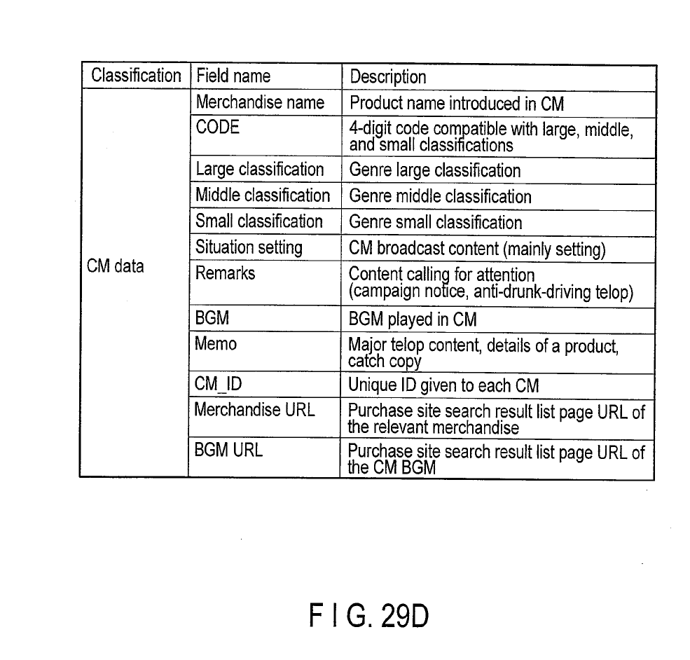

Each of FIGS. 29A, 29B, 29C, and 29D shows a list of metadata. The data is related to the creation of scene information. That is, broadcast history data, merchandise data, outlet data, and CM broadcast history data stored in a database in the metadata server are related to one another, thereby creating scene information.

Here, neither merchandise information nor outlet information may exist in one piece of scene information. In addition, a plurality of merchandise data items (e.g., trade names) and outlet data items (e.g., company's names or agency's names) may be related to one another in one piece of scene information.

With the information processing apparatus, configurations described below can be realized.

(1) An information processing apparatus comprising an overall controller that communicates with a server connected to a network and a view control module that controls a display image,

wherein the view control module outputs a menu image obtained, in a case where the overall controller has gone into communication with the network, as a demonstration image to a display module when the overall controller is out of communication with the network,

the overall controller includes a login data management module and a communication data management module,

the login management module distinguishes between a common login identifier for more than one person and a dedicated login identifier for an individual and manages them, and

the communication data management module performs display control so as to distinguish between communication data corresponding to the common login identifier and communication data corresponding to the dedicated login identifier.

(2) The information processing apparatus as in (1), wherein the login management module is capable of transmitting an identifier currently logging in to the server periodically.

(3) The information processing apparatus as in (1), wherein the overall controller and the view control module receive information on one other person currently logging into the server from the server and output, to the display module, an image representing a login state of the one other person to the server.

(4) The information processing apparatus as in (3), wherein the image representing the login state of the one other person determines whether the one other person is viewing the same program as a program being displayed on the display module.

(5) The information processing apparatus as in (1), wherein the communication data management module controls communication data corresponding to the dedicated login identifier on the display module privately (no openly) when the common login identifier has logged in.

(6) An information processing method for an apparatus including an overall controller that communicates with a server connected to a network and a view control module that controls a display image, the information processing method comprising:

outputting a menu image obtained in a case where the overall controller has gone into communication with the network as a demonstration image to a display module when the overall controller is out of communication with the network,

causing a login management module to distinguish between a common login identifier for more than one person and a dedicated login identifier for an individual and manage them, and

causing a communication data management module to perform display control so as to distinguish between communication data corresponding to the common login identifier and communication data corresponding to the dedicated login identifier.

(7) The information processing method as in (6), further comprising: transmitting an identifier currently logging in to the server periodically.

(8) The information processing method as in (6), further comprising: receiving information on one other person currently logging into the server from the server and outputting, to the display module, an image representing a login state of the one other person to the server.

(9) The information processing method as in (8), wherein the image representing the login state of the one other person determines whether the one other person is viewing the same program as a program being displayed on the display module.

(10) The information processing method as in (6), further comprising: controlling communication data corresponding to the dedicated login identifier on the display module privately (no openly) when the common login identifier is in a login state.

(11) A digital television receiving apparatus which comprises an information processing apparatus that includes an overall controller that communicates with a server connected to a network and a view control module that controls a display image,

wherein the view control module outputs a menu image obtained in a case where the overall controller has gone into communication with the network as a demonstration image to a display module when the overall controller is out of communication with the network,

the overall controller includes a login data management module and a communication data management module,

the login management module distinguishes between a common login identifier for more than one person and a dedicated login identifier for an individual and manages them, and

the communication data management module is capable of performing display control so as to distinguish between communication data corresponding to the common login identifier and communication data corresponding to the dedicated login identifier.

(12) The digital television receiving apparatus as in (11), wherein the login management module is capable of transmitting an identifier currently logging in to the server periodically.

(13) The digital television receiving apparatus as in (11), wherein the overall controller and the view control module receive information on one other person currently logging into the server from the server and output, to the display module, an image representing a login state of the one other person to the server.

(14) The digital television receiving apparatus as in (13), wherein the image representing the login state of the one other person determines whether the one other person is viewing the same program as a program being displayed on the display module.

(15) A storage medium which stores a computer-readable program composed of a set of instructions and configured so as to control an apparatus that includes an overall controller that communicates with a server connected to a network and a view control module that controls a display image, the program

performing control so as to output a menu image obtained in a case where the overall controller has gone into communication with the network as a demonstration image to a display module when the overall controller is out of communication with the network,

performing control so as to cause a login management module to distinguish between a common login identifier for more than one person and a dedicated login identifier for an individual and manages them, and

performing control so as to cause a communication data management module to perform display control to distinguish between communication data corresponding to the common login identifier and communication data corresponding to the dedicated login identifier.

(16) The storage medium as in (15), wherein the program performs control so as to transmit an identifier currently logging in to the server periodically.

(17) The storage medium as in (15), wherein the program performs control in connection with control of the overall controller and the view control module so as to receive information on one other person currently logging into the server from the server and output, to the display module, an image representing a login state of the one other person to the server.

(18) The storage medium as in (17), wherein the program performs control so as to cause the image representing the login state of the one other person to determine whether the one other person is viewing the same program as a program being displayed on the display module.

In the above explanation, even when a claim is expressed by dividing a structural element of the claim into subelements, by putting some of the subelements together, or by combining the subelements, it is still in the scope of the invention.

Furthermore, even when a claim is expressed as a method, the method is equivalent to the application of an apparatus of the invention. Moreover, the name of each part is not restrictive. Of course, it may be replaced with a module, a block, a unit, a circuit, means, a part, a device, or the like.

The technical terms used above in relation to the embodiments and the names or technical terms described in the drawings are in no way restrictive. For example, the processor may be replaced with processing means, a processing unit, or a processing module. Likewise, the controller may be replaced with control means, a control unit, or a control module.

The managing unit may be replaced with a manager, managing means, or a managing module. The generator may be replaced with generating means, a generating unit, or a generating module. The storage unit may be replaced with storage means, a storage, or a storage module. The collection and correction unit may be replaced with collection and correction means, or a collection and correction device. The registration unit may be replaced with registration means, a registration device, or a registration module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first controller configured to output viewing content to a display module;
a second controller configured to display a service menu related to the content in a list form on the display module when an instruction to acquire a service from a specific server has been received while the content is being output to the display module; and
a third controller configured to switch to a further related service menu and display the further related service menu in response to a subsequent specification input according to a display state of the service menu.

2. The information processing apparatus of claim 1, wherein the first to third controllers communicate mutually with the server connected to a network and,
output a menu image as a demonstration image to the display module when the first to third controllers are out of communication with the network, wherein the menu image is same as an image obtained in a case where the first to third controllers have gone into communication state with the network.

3. The information processing apparatus of claim 1, wherein the first to third controllers are configured to distinguish between a common login identifier for more than one person and a dedicated login identifier for an individual and manage them, and
to perform display control so as to distinguish between communication data corresponding to the common login identifier and communication data corresponding to the dedicated login identifier.

4. The information processing apparatus of claim 3, wherein the first to third controllers are configured to control communication data corresponding to the dedicated login identifier on the display module privately, when the common login identifier has logged in.

5. The information processing apparatus of claim 3, wherein the first to third controllers are capable of transmitting an identifier currently logging in to the server periodically.

6. The information processing apparatus of claim 1, wherein the first to third controllers are configured to receive information on one other person currently logging into the server from the server and to output, to the display module, an image representing a login state of the one other person to the server.

7. The information processing apparatus of claim 6, wherein the image representing the login state of the one other person is configured to determine whether the one other person is viewing the same program as a program being displayed on the display module.

8. A method of controlling an information processing apparatus which includes a first controller configured to output viewing content to a display module, a second controller configured to display a menu, and a third controller configured to switch menus, the method comprising:
causing the first to third controllers to display a service menu related to the content in a list form on the display module when the first to third controllers have received an instruction to acquire a service from a specific server while the content is being output on the display module; and
causing the first to third controllers to switch to a further related service menu and display the further related service menu in response to a subsequent specification input according to a display state of the service menu.

9. The method of claim 8, further comprising:
communicating mutually with the server connected to a network and;
outputting a menu image as a demonstration image to the display module when communication is not established with the network, wherein the menu image is same as an image obtained in a case where communication has been established with the network.

10. The method of claim 8, further comprising:
distinguishing between a common login identifier for more than one person and a dedicated login identifier for an individual and managing them; and
performing display control so as to distinguish between communication data corresponding to the common login identifier and communication data corresponding to the dedicated login identifier.

11. The method of claim 10, further comprising:
controlling communication data corresponding to the dedicated login identifier on the display module privately, when the common login identifier has logged in.

12. The method of claim 11, further comprising:
displaying a plurality of guide images for transmit-receive boxes when the common login identifier has logged in.

13. The method of claim 11, further comprising:
being capable of transmitting an identifier currently logging in to the server periodically.

14. The method of claim 8, further comprising:
receiving information on one other person currently logging into the server from the server and outputting, to the display module, an image representing a login state of the one other person to the server.

15. The method of claim 14, wherein the image representing the login state of the one other person determines whether the one other person is viewing the same program as a program being displayed on the display module.

16. A digital television receiving apparatus comprising an information processing apparatus, the information processing apparatus comprising:
a first controller configured to output viewing content to a display module;
a second controller configured to display a service menu related to the content in a list form on the display module when having received an instruction to acquire a service from a specific server while the content is being output to the display module; and
a third controller configured to switch to a further related service menu and displays the further related service menu in response to a subsequent specification input according to a display state of the service menu.

17. A storage medium configured to store a program composed of a set of instructions configured to cause a computer to realize functions, the instructions comprising:
a first instruction configured to realize a function of outputting viewing content to a display module,
a second instruction configured to realize a function of outputting a menu for display,
a third instruction configured to realize a function of switching menus,
a fourth instruction configured to realize a function of displaying a service menu related to the content in a list form on the display module when a fifth instruction configured to acquire a service from a specific server has been received while the content is being output on the display module, and
a sixth instruction configured to realize a function of switching to a further related service menu and displaying the further related service menu in response to a subsequent specification input according to a display state of the service menu.
